(19) United States
(12) Patent Application Publication
(10) Pub. No.: US 2013/0076742 A1
(43) Pub. Date: Mar. 28, 2013

(54) REPRODUCTION APPARATUS, DISPLAY APPARATUS, AMPLIFIER APPARATUS, AND IMAGE SYSTEM

(71) Applicant: Tetsuya Itani, Nara (JP)

(72) Inventor: Tetsuya Itani, Nara (JP)

(73) Assignee: PANASONIC CORPORATION, Osaka (JP)

(21) Appl. No.: 13/702,611

(22) PCT Filed: Jun. 13, 2011
(86) PCT No.: PCT/JP2011/003339

§ 371 Date: Dec. 7, 2012

(30) Foreign Application Priority Data
Jun. 11, 2010 (JP) 2010-133635

(51) Int. Cl. G06T 15/00

(52) U.S. Cl. CPC G06T 15/00
USPC 345/419

(57) ABSTRACT

A reproducing device capable of superimposing a reproducing device image onto a stereoscopic image which can be viewed stereoscopically to generate and output a stereoscopic image signal. The reproducing device includes: an acquisition unit operable to obtain information about device image depth, the device image depth being stereoscopic vision depth that a device connected to the reproducing device and capable of superimposing a device image onto the stereoscopic image gives to the device image when the device superimposes the device image onto the stereoscopic image; a superimposing unit operable to give reproducing device image depth to the reproducing device image based on the information about device image depth obtained by the acquisition unit and superimpose the reproducing device image onto the stereoscopic image to generate the stereoscopic image signal; and a transmission unit operable to transmit the stereoscopic image signal to the device.

### TECHNICAL FIELD

The technical field relates to a technique of reproducing and displaying an image, and in particular, to a reproducing device, an amplification device, a display device, and a video system, in which an On Screen Display (OSD) is generated and displayed in stereoscopic image reproduction and display.

### BACKGROUND ART

Display devices which perform stereoscopic display of an image, and reproducing devices which reproduce stereoscopic images, or the like have gradually come to be manufactured. In addition, displaying the On Screen Display (OSD) on a display screen so that a viewer can easily use the display device or the reproducing device has been known. In general, the OSD displays information for notifying a user of a state of equipment such as a reproducing device, an amplifier (AV amplifier), and a display device, or reproduction additional information, or the like using character information or an icon. The OSD is displayed by being overwritten on a part of a main image which is reproduced.

In Patent Document 1 (JP 11-289555 A), a configuration is disclosed in which, when character information including stereoscopic display attribute information is delivered, the information is decoded so as to be displayed as a stereoscopic image by a character information decoder, and an image is synthesized from the decoded image and the main image by a synthesizer to supply the image to a display device for stereoscopically display. In this manner, it is possible to perform a stereoscopic display of the character, and to provide an image with a sense of reality.

### CITATION LIST

### Patent Literature

PTL 1: JP 11-289555 A

### Summary Technical Problem

However, when OSDs (device images) are displayed in a superimposed manner by being overwritten on an image by a plurality of devices such as a reproducing device, a display device, and the like, the OSD (device image) which is superimposed later is overwritten on an image including the OSD (device image) which has been superimposed earlier. Accordingly, when the stereoscopic display position (sense of depth in stereoscopic vision) of the OSD (device image) which is superimposed later located behind the stereoscopic display position of the OSD (device image) which has been superimposed earlier, a contradiction occurs between a display of the images and stereoscopic positions, and as a result, there has been a problem in that a viewer feels a sense of uneasiness.

In consideration of such a problem in the above-described related art, a reproducing device, a display device, and a video system which realize a device image display with high visibility for a viewer are provided.

### Solution to Problem

First aspect is a reproducing device capable of superimposing a reproducing device image different from a stereoscopic image onto the stereoscopic image which can be viewed stereoscopically to generate and output a stereoscopic image signal. The reproducing device includes: an acquisition unit operable to obtain information about device image depth, the device image depth being stereoscopic vision depth that a device connected to the reproducing device and capable of superimposing a device image different from the stereoscopic image onto the stereoscopic image gives to the device image when the device superimposes the device image onto the stereoscopic image; a superimposing unit operable to give reproducing device image depth to the reproducing device image based on the information about device image depth obtained by the acquisition unit and superimpose the reproducing device image onto the stereoscopic image to generate the stereoscopic image signal; and a transmission unit operable to transmit the stereoscopic image signal cc the device.

Second aspect is a reproducing device capable of superimposing a reproducing device image different from a stereoscopic image onto the stereoscopic image which can be viewed stereoscopically to generate and output a stereoscopic image signal. The reproducing device includes: a superimposing unit operable to superimpose the reproducing device image onto the stereoscopic image to generate the stereoscopic image signal; and a transmission unit operable to transmit the stereoscopic image signal and information about stereoscopic vision depth of the reproducing device image to a device connected to the reproducing device and capable of superimposing a device image different from the stereoscopic image onto the stereoscopic image.

Third aspect is a display device capable of superimposing a display device image different from a stereoscopic image onto the stereoscopic image which can be viewed stereoscopically to display the stereoscopic image. The display device includes: a reception unit operable to receive a first stereoscopic image signal including the stereoscopic image; an acquisition unit operable to obtain information about device image depth, the device image depth being stereoscopic vision depth that a device connected to the display device and capable of superimposing a device image different from the stereoscopic image onto the stereoscopic image to output the first stereoscopic image signal gives to the device image when the device superimposes the device image onto the stereoscopic image; a superimposing unit operable to give display device image depth to the display device image based on the information about device image depth obtained by the acquisition unit and superimpose the display device image onto the stereoscopic image to generate a second stereoscopic image signal; and a display unit operable to display an image based on the second stereoscopic image signal.

Fourth aspect is a display device capable of superimposing a display device image different from stereoscopic image onto the stereoscopic image which can be viewed stereoscopically to display the stereoscopic image. The display device includes: a superimposing unit operable to superimpose the display device image onto the stereoscopic image included in a first stereoscopic image signal to generate a second stereoscopic image signal; and a transmission unit operable to transmit information about stereoscopic vision depth of the display device image to a device connected to the display device and capable of superimposing a device image different from the stereoscopic image onto the stereoscopic image to output the first stereoscopic image signal.

Fifth aspect is an amplification device capable of receiving a first stereoscopic image signal including a stereoscopic image which can be viewed stereoscopically from a reproducing device and superimposing an amplification device image different from the stereoscopic image onto the stereoscopic image to generate and transmit a second stereoscopic image signal to a display device. The amplification device includes: a reception unit operable to receive the first stereoscopic image signal; an acquisition unit operable to obtain information about display device image depth, the display device image depth being stereoscopic vision depth that the display device capable of superimposing a display device image different from the stereoscopic image onto the stereoscopic image gives to the display device image when the display device superimposes the display device image onto the stereoscopic image; a superimposing unit operable to give amplification device image depth to the amplification device image based on the information about display device image depth obtained by the acquisition unit and superimpose the amplification device image onto the stereoscopic image to generate a second stereoscopic image signal; and a transmission unit operable to transmit the second stereoscopic image signal to the display device.

Sixth aspect is an amplification device capable of receiving a first stereoscopic image signal including a stereoscopic image which can be viewed stereoscopically from a reproducing device and superimposing an amplification device image different from the stereoscopic image onto the stereoscopic image to generate and transmit a second stereoscopic image signal to a display device. The amplification device includes: a reception unit operable to receive the first stereoscopic image signal; a superimposing unit operable to superimpose the amplification device image onto the stereoscopic image to generate the second stereoscopic image signal; a transmission unit operable to transmit the second stereoscopic image signal to the display device; and a notification unit operable to notify at least one of the reproducing device and the display device of information about stereoscopic vision depth of the amplification device image.

Seventh aspect is an amplification device capable of receiving a first stereoscopic image signal including a stereoscopic image which can be viewed stereoscopically from a reproducing device and superimposing an amplification device image different from the stereoscopic image onto the stereoscopic image to generate and transmit a second stereoscopic image signal to a display device. The amplification device includes: a reception unit operable to receive the first stereoscopic image signal; an acquisition unit operable to obtain information about reproducing device image depth, the reproducing device image depth being stereoscopic vision depth that the reproducing device capable of superimposing a reproducing device image different from the stereoscopic image onto the stereoscopic image gives to the reproducing device image when the reproducing device superimposes the reproducing device image onto the stereoscopic image; a superimposing unit operable to give amplification device image depth to the amplification device image based on the information about reproducing device image depth obtained by the acquisition unit and superimpose the amplification device image onto the stereoscopic image to generate the second stereoscopic image signal; and a transmission unit operable to transmit the second stereoscopic image signal to the display device.

Eighth aspect is a video system including a reproducing device, a display device, and an amplification device. The reproducing device is capable of superimposing a reproducing device image being an image different from a stereoscopic image onto the stereoscopic image which can be viewed stereoscopically to generate and output a first stereoscopic image signal, which includes: an acquisition unit operable to obtain information about amplification device image depth, the amplification device image depth being stereoscopic vision depth that the amplification device connected to the reproducing device and capable of superimposing a amplification device image different from the stereoscopic image onto the stereoscopic image gives to the amplification device image when the amplification device superimposes the amplification device image onto the stereoscopic image; a superimposing unit operable to give reproducing device image depth to the reproducing device image based on the information about amplification device image depth obtained by the acquisition unit and superimpose the reproducing device image onto the stereoscopic image to generate the first stereoscopic image signal; and a transmission unit operable to transmit the first stereoscopic image signal to the amplification device. The amplification device is capable of receiving the first stereoscopic image signal from the reproducing device and superimposing the amplification device image different from the stereoscopic image onto the stereoscopic image to generate and transmit a second stereoscopic image signal to a display device, which includes: a reception unit operable to receive the first stereoscopic image signal; an acquisition unit operable to obtain information about display device image depth, the display device image depth being stereoscopic vision depth that the display device capable of superimposing a display device image different from the stereoscopic image onto the stereoscopic image gives to the display device image when the display device superimposes the display device image onto the stereoscopic image; a superimposing unit operable to give the amplification device image depth to the amplification device image based on the information about display device image depth obtained by the acquisition unit and superimpose the amplification device image onto the stereoscopic image to generate the second stereoscopic image signal; and a transmission unit operable to transmit the second stereoscopic image signal to the display device. The display device is capable of receiving the second stereoscopic image signal from the amplification device and superimposing the display device image different from the stereoscopic image onto the stereoscopic image to display the stereoscopic image, which includes: a reception unit operable to receive the second stereoscopic image signal; a superimposing unit operable to give the display device image depth to the display device image and superimpose the display device image onto the stereoscopic image to generate a third stereoscopic image signal; and a display unit operable to display an image based on the third stereoscopic image signal.

Ninth aspect is a video system including a reproducing device, a display device, and an amplification device. The reproducing device is capable of superimposing a reproducing device image different from a stereoscopic image onto the stereoscopic image which can be viewed stereoscopically to generate and output a first stereoscopic image signal, which includes: a superimposing unit operable to give reproducing device image depth of a predetermined stereoscopic vision depth to the reproducing device image and superimpose the reproducing device image onto the stereoscopic image to generate the first stereoscopic image signal; and a transmission unit operable to transmit the first stereoscopic image signal to the amplification device. The amplification device is capable of receiving the first stereoscopic image signal from the reproducing device and superimposing an amplification device image different from the stereoscopic image onto the stereoscopic image to generate and transmit a second stereoscopic image signal to a display device, which includes: a reception unit operable to receive the first stereoscopic image signal; an acquisition unit operable to obtain information about reproducing device image depth; a superimposing unit operable to give amplification device image depth to the amplification device image based on the information about reproducing device image depth obtained by the acquisition unit and superimpose the amplification device image onto the stereoscopic image to generate the second stereoscopic image signal; and a transmission unit operable to transmit the second stereoscopic image signal to the display device. The display device is capable of receiving the second stereoscopic image signal from the amplification device and superimposing a display device image different from the stereoscopic image onto the stereoscopic image to display the stereoscopic image, which includes: a reception unit operable to receive the second stereoscopic image signal; an acquisition unit operable to obtain information about amplification device image depth; a superimposing unit operable to give display device image depth to the display device image based on the information about amplification device image depth obtained by the acquisition unit and superimpose the display device image onto the stereoscopic image to generate a third stereoscopic image signal; and a display unit operable cc display an image based on the third stereoscopic image signal.

### ADVANTAGEOUS EFFECTS OF INVENTION

The reproducing device can display an OSD which is highly visible for a viewer by determining a sense of depth of a reproducing device image of the reproducing device based on the sense of depth of a device image of a device connected to the reproducing device such as an amplification device or a display device.

The display device can display an OSD which is highly visible for a viewer by determining a sense of depth of a display device image of the display device based on the sense of depth of a device image of a device connected to the display device such as the reproducing device or the amplification device.

The amplification device can display an OSD which is highly visible for a viewer by determining a sense of depth of a amplification device image of the amplification device based on the sense of depth of a device image of a device connected to the amplification device such as the reproducing device or the display device.

In a video system which includes the above-described reproducing device, amplification device, and display device, it is possible to display OSDs which are highly visible for a viewer, since each sense of depth of the device images of the devices is determined based on the sense of depth of other device images of other devices.

### BRIEF DESCRIPTION OF DRAWINGS

FIG. 1 is a block diagram illustrating configurations of a reproducing device and a display device according to a first embodiment.

FIG. 2A is a flowchart of operation of the reproducing device according to the first embodiment.

FIG. 2B is a flowchart of operation of the display device according to the first embodiment.

FIG. 3 is a schematic diagram describing a principle of a depth (sense of depth) in a stereoscopic display.

FIG. 4 is a schematic diagram illustrating a data structure of an HDMI signal in the first embodiment.

FIG. 5 is a schematic diagram illustrating each display depth of a plurality of OSDs.

FIG. 6 is a block diagram illustrating configurations of a reproducing device and a display device according to a second embodiment.

FIG. 7A is a flowchart of operation of the reproducing device according to the second embodiment.

FIG. 7B is a flowchart of operation of the display device according to the second embodiment.

FIG. 8 is a schematic diagram illustrating a data structure of an HDMI signal in the second embodiment.

FIG. 9 is a schematic diagram illustrating each display depth of a plurality of OSDs.

FIG. 10 is a block diagram illustrating a configuration of a video system according to a third embodiment.

FIG. 11A is a flowchart of operation of the amplification device according to the third embodiment.

FIG. 11B is a flowchart of operation of the reproducing device according to the third embodiment.

FIG. 11C is a flowchart of operation of the display device according to the third embodiment.

FIG. 12 is a schematic diagram illustrating a data structure of an HDMI signal in the third embodiment.

FIG. 13 is a schematic diagram illustrating a data structure of an HDMI signal in the third embodiment.

FIG. 14 is a schematic diagram illustrating each display depth of a plurality of OSDs.

FIG. 15 is a block diagram illustrating a configuration of a video system according to a fourth embodiment.

FIG. 16A is a flowchart of operation of the reproducing device according to the fourth embodiment.

FIG. 16B is a flowchart of operation of the amplification device according to the fourth embodiment.

FIG. 16C is a flowchart of operation of the display device according to the fourth embodiment.

FIG. 17 is a schematic diagram illustrating a data structure of an HDMI signal in the fourth embodiment.

FIG. 18 is a schematic diagram illustrating a data structure of an HDMI signal in the fourth embodiment.

FIG. 19 is a schematic diagram illustrating each display depth of a plurality of OSDs.

FIG. 20 is a block diagram illustrating a configuration of a video system according to a fifth embodiment.

FIG. 21A is a flowchart of operation of the reproducing device according to the fifth embodiment.

FIG. 21B is a flowchart of operation of the display device according to the fifth embodiment.

FIG. 22 is a schematic diagram illustrating each display depth of a plurality of OSDs.

FIG. 23 is a schematic diagram illustrating a data structure of an HDMI signal in the fifth embodiment.

### DESCRIPTION OF EMBODIMENTS

Hereinafter, embodiments will be described in detail with reference to the accompanying drawings.

### 1. First Embodiment

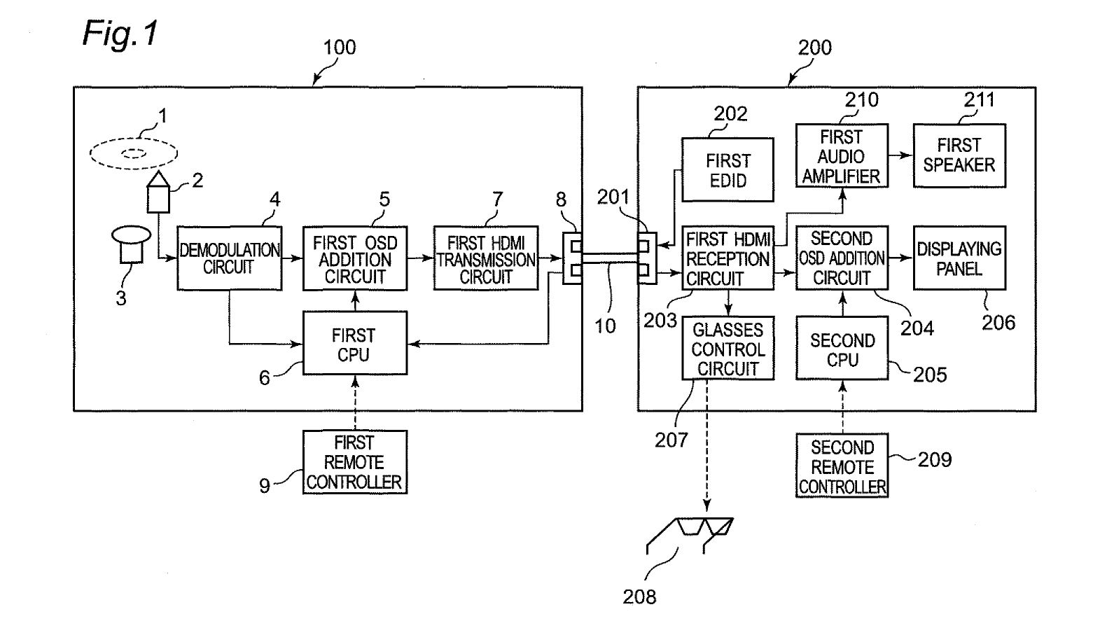

Hereinafter, a reproducing device and a display device according to a first embodiment will be described. The reproducing device and the display device according to the present embodiment can be industrially produced based on an internal configuration diagram illustrated in FIG. 1.

1-1. Regarding Configuration

FIG. 1 is a block diagram which illustrates an internal configuration of a first reproducing device 100 and a first display device 200 according to the first embodiment. In this figure, the first reproducing device 100 is an image reproducing device capable of reproducing an optical disc 1. The first reproducing device 100 includes an optical pickup 2, a motor 3, a demodulation circuit 4, a first OSD addition circuit 5, a first CPU (Central Processing Unit) 6, a first HDMI (High Definition Multimedia Interface) transmission circuit 7, a first output terminal 8, and a first remote controller 9.

A first display device 200 includes a first input terminal 201, a first EDID (Extended Display ID) 202, a first HDMI reception circuit 203, a second OSD addition circuit 204, a second CPU 205, a displaying panel 206, a glasses control circuit 207, stereoscopic vision glasses 208, a second remote controller 209, a first audio amplifier 210, and a first speaker 211.

In addition, the first output terminal 8 of the first reproducing device 100 and the first input terminal 201 of the first display device 200 are connected to each other through a first cable 10.

The optical disc 1 is recorded with stereoscopic image signals and audio signals which are subjected to MPEG (Moving Picture Experts Group) 4 compression.

The optical pickup 2 converts signals which are recorded in the optical disc 1 to electrical signals.

The motor 3 rotates the optical disc 1 at a speed which is suitable for reproducing.

The demodulation circuit 4 inputs an output of the optical pickup 2, performs an error correction or the like in the input, and demodulates it into the stereoscopic image signal and the audio signal. As will be described later, the first reproducing device 100 transmits an uncompressed frame image to a television through an HDMI transmission path. The demodulation circuit 4 performs a demodulation process with respect to the frame image which is encoded using an MPEG 4 encoding method, and generates and outputs an image signal which configures the frame image. A demultiplexer, or a video decoder which is necessary for performing decoding with respect to the frame image encoded using the MPEG 4 encoding method is mounted in the demodulation circuit 4.

The first OSD addition circuit 5 overwrites (superimposes) an image of information (OSD information, hereinafter, also abbreviated as “OSD”) which is configured by characters or icons on respective image signals of a left eye image and a right eye image which are included in a stereoscopic image signal which is output from the demodulation circuit 4, and outputs the signals.

The first CPU 6 is a microprocessor which controls the first reproducing device 100. The first CPU 6 controls the first OSD addition circuit and generates OSD information as necessary based on reproducing information which is obtained by operation of a user which is sent from the first remote controller 9, or the demodulation circuit 4.

The first HDMI transmission circuit 7 modulates a stereoscopic image output of the first OSD addition circuit 5, an audio output of the demodulation circuit 4, or the like to a digital image signal of an HDMI format, and outputs the signal to the first display device 200 from the first output terminal 8.

The first output terminal 8 is a video-audio output terminal which conforms to the HDMI standard, and a transmission path of a video-audio signal which has been subjected to digital modulation, and a serial transmission path for mutual communication which is prescribed in both standards of the VESA (Video Electronics Standard Association)/E-DDC (Enhanced Display Data Channel), and EIA (Electronics Industries Association)/CEA (Consumer Electronics Association) 861-D are included therein.

The first remote controller 9 is operated by a user, and delivers instructions such as a reproducing start, stop, information display, or the like to the first reproducing device 100.

The first cable 10 is a signal transmission cable which conforms to the HDMI standard.

Regarding the first display device 200, the first input terminal 201 is a video-audio input terminal which conforms to the HDMI standard, and the transmission path of the video-audio signal which has been subjected to the digital modulation, and the serial transmission path for mutual communication which is prescribed in both the standards of the VESA/E-DDC and EIA/CEA 861-D are included therein.

The first EDID 202 includes a memory element in which information relating to functions which are included in the first display device 200 is stored, and stores the information in a form of a data array determined in the EDIT standard of the EIA/CEA 861-D. According to the present embodiment, the first EDID 202 is further added with information indicating an OSD display depth of the first display device 200 to be described later, that is, OSD depth information therein.

The first HDMI reception circuit 203 receives the HDMI signal through the first input terminal 201, and demodulates it into a stereoscopic image signal, synchronization signal, and an audio signal.

The second OSD addition circuit 204 overwrites (superimposes) characters, or an image of icon information (OSD) on the respective image signals of the left eye image and the right eye image of the stereoscopic image signal which is output from the first HDMI reception circuit 203, and outputs the signals.

The second CPU 205 is a microprocessor which controls the first display device 200. The second CPU 205 controls the second OSD addition circuit 204, and generates OSD information including the OSD depth information according to a user's instruction sent from the second remote controller 209.

The displaying panel 206 is a displaying device including 1080 pixels in the vertical direction, and 1920 pixels in the horizontal direction, and an image is displayed to a user (viewer) using the displaying panel 206.

The glasses control circuit 207 controls a shutter of the stereoscopic vision glasses 208 using an infrared signal according to an image synchronization signal for the right eye image and the left eye image which is obtained from the first HDMI reception circuit 203. The stereoscopic vision glasses 208 include liquid crystal shutters which are separated on the left and right, and are able to control transmission and non-transmission of light, and has a structure in which opening and closing of the shutters are independently possible on the left and right, according to the infrared signal from the glasses control circuit 207.

The second remote controller 209 is operated by a user, and delivers instructions such as information display, stop, or the like to the first display device 200.

The first audio amplifier 210 amplifies an audio signal. The first speaker 211 converts an output of the first audio amplifier 210 into audio.

1-2. Regarding Operation

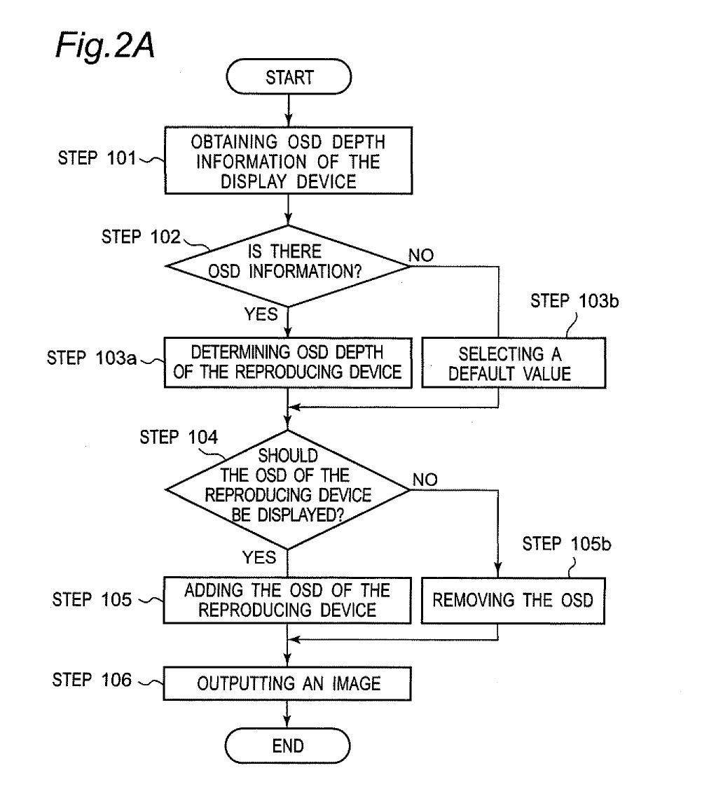

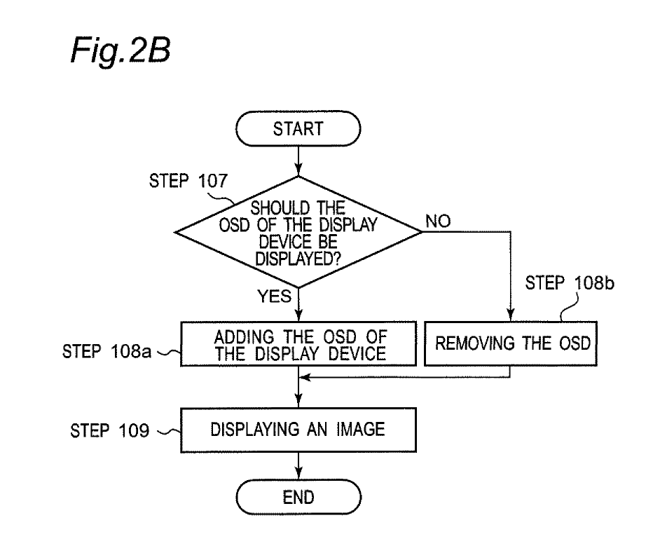

FIGS. 2A and 2B are flowcharts which illustrate operation of the first reproducing device 100 and the first display device 200 according to the first embodiment. Hereinafter, the operation of the first reproducing device 100 and the first display device 200 will be described with reference to the flowcharts.

1-2-a. Outline of Operation of First Reproducing Device 100 and First Display Device 200

FIG. 2A is a flowchart relating to operation of the first reproducing device 100. With reference to FIG. 2A, first, in step 101, the first reproducing device 100 obtains OSD depth information of the first display device 200.

Subsequently, in step 102, the first reproducing device 100 determines the presence or absence of the OSD depth information of the first display device 200. Here, when there is the OSD depth information of the first display device 200, the first reproducing device 100 adjusts the OSD display depth of the first reproducing device 100 based on the OSD depth information of the first display device 200 in step 103a. In step 102, when there is no OSD depth information of the first display device 200, the first reproducing device 100 selects a preset default value as the OSD display depth of the first reproducing device 10C (step 103b).

Subsequently, in step 104, the first reproducing device 100 determines whether or not to instruct a display of the OSD of the first reproducing device 100. Here, when there is a display instruction, the first reproducing device 100 adds the OSD of the first reproducing device 100 to an image signal in step 105a. When there is no display instruction, the first reproducing device 100 removes (or does not add) the OSD (step 105b).

Subsequently, in step 106, the first reproducing device 100 outputs an image signal to the first display device 200.

When continuously outputting images, step 104 to step 106 are repeated.

FIG. 2B is a flowchart relating to operation of the first display device 200. With reference to FIG. 2B, the first display device 200 determines whether or not to instruct the display of the OSD of the first display device 200 in step 107. Here, when there is a display instruction, the first display device 200 adds the OSD of the first display device 200 to an image signal in step 108a. When there is no display instruction, the first display device 200 removes (or does not add) the OSD (step 108b).

Finally, in step 109, the first display device 200 displays an image on the displaying panel 206.

When continuously displaying images, step 107 to step 109 are repeated.

1-2-B. Control of OSD Display Depth

The first reproducing device 100 is provided with the first OSD addition circuit 5. The first display device 200 is provided with the second OSD addition circuit 204. The first OSD addition circuit 5 has a function of changing the OSD display depth.

Here, controlling of the OSD display depth will be described. The OSD itself is configured by a two-dimensional (non-stereoscopic) graphic bitmap. In addition, the OSD display depth (front-back position of stereoscopic image) is variable.

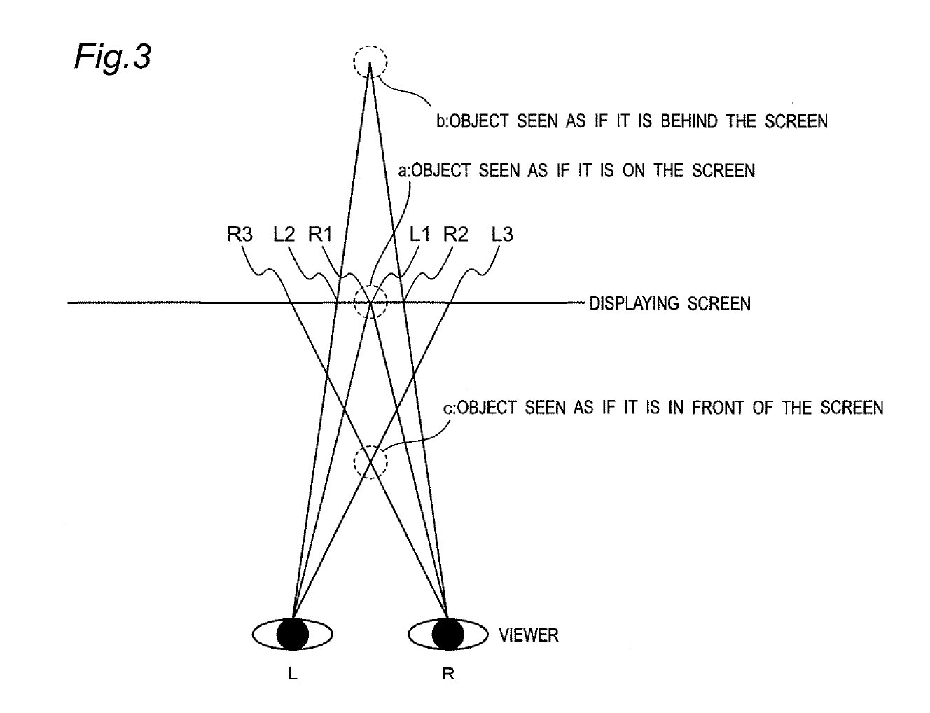

FIG. 3 is a diagram which describes a principle of the depth (sense of depth) in a stereoscopic display. When a: an object is seen as if it is written on a screen from a viewer, a position of the object in a right eye image (right eye position R1) matches to a position in a left eye image (left eye position L1). When b: an object is seen as if it is behind the screen from a viewer, left eye information of the object is L2, and right eye information is R2. That is, the left eye information moves to the left from L1 to L2 according to the sense of depth (depth) given to the object, and the right eye information moves further to the right from R1 to R2. Localization of the object behind the screen is determined by a magnitude of the amount of movement.

When c: an object is seen as if it is at a position protruded from the screen from a viewer, the right eye information is R3, and the left eye information is L3. That is, the left eye information moves to the right from L1 to L3 according to the sense of depth (depth) given to the object, and the right eye information moves to the left from R1 to R3. Localization of the object to the front from the screen is determined by a magnitude of the amount of movement.

In this manner, it is possible to move the sense of depth (depth) of the object back and forth by adding an offset to a position (information position) in the left eye image and the right eye image even in the same object.

In the first reproducing device 100 and the first display device 200, the OSD depth information is prescribed as the number of offset pixels from L1 (R1). That is, as illustrated in Table 1, the OSD depth information has a value of 8 bits, and is represented by values from 0 to 255 (offset amount). The offset to the left is represented by − (minus), and the offset to the right is represented by + (plus) with respect to the left eye image. The offset to the right is represented by − (minus), and the offset to the left is represented by + (plus) with respect to the right eye image.

Accordingly, the OSD is located most behind when the OSD depth information is zero. When the OSD depth information is 128, the offset amount becomes zero, and the CSD is located on the screen. When the OSD depth information is 255, the OSD is located at the most front side.

TABLE 1

| OSD Depth | Offset of Left Eye | Offset of Right Eye |
|---|---|---|
| Information | OSD Information | OSD Information |
| 0 | 128 pixels to left | 128 pixels to right |
| 128 | 0 pixel | 0 pixel |
| 255 | 127 pixels to right | 127 pixels to left |

In the first display device 200 according to the present embodiment, the OSD depth information which is determined as above is recorded at a predetermined position in the first EDID 202.

1-2-c. Details of operation of first reproducing device 100 and first display device 200

(1) Operation of First Reproducing Device 100

(1a) Reading Out of First EDID 202 by First CPU 6

The first CPU 6 of the first reproducing device 100 reads the first EDID 202 of the first display device 200 in step 101. The first EDID 202 is a non-volatile memory, information relating to functions of the first display device 200 such as an image format which is prescribed in the EIA/CEA861-D standard, or the like is mainly stored here, and the OSD depth information to be described later is recorded together. The first CPU 6 reads the OSD depth information of the first display device 200 through a serial transmission path which passes through the first cable 10, and determined in the VESA/E-DDC standard.

The first reproducing device 100 transmits an image signal and an audio signal in an image format which can be displayed by the first display device 200 according to information of the first EDID 202.

(1b) Determination of OSD Display Depth of First Reproducing Device 100

The first CPU 6 of the first reproducing device 100 which has read the CSD depth information of the first display device 200 which is recorded in the first EDID 202 determines the OSD display depth of the first reproducing device 10C based on the value according to the flowchart illustrated in FIG. 2A.

That is, the first CPU 6 determines the OSD display depth of the device itself so that the OSD of the first reproducing device 100 is not located at the front side of (so as to be located behind) the OSD of the first display device 200.

For example, when a value of the OSD depth information which is stored in the first EDID 202 of the first display device 200 is “192”, an OSD offset of the first display device 200 becomes 192−128=+64. Accordingly, the OSD of the first display device 200 is given with the offset of 64 pixels, and is displayed so as to be seen as if it is in front of the screen from a viewer.

Here, the first CPU 6 selects, for example, “160” which is smaller than “192” as the OSD depth information of the first reproducing device 100. In this manner, the OSD offset of the first reproducing device 100 becomes 160−128=+32. Accordingly, the OSD of the first reproducing device 100 is given with an offset of 32 pixels, and is displayed so as to be seen behind the OSD of the first display device 200 from a viewer.

(1c) Reproducing of Image Signal and Audio Signal

The optical disc 1 is recorded with a stereoscopic image signal and an audio signal which are compressed by the MPEG 4 method. The optical pickup 2 converts signals recorded in the optical disc 1 to electrical signals. The motor 3 rotates the optical disc 1 at suitable speed for reproducing.

The demodulation circuit 4 inputs an output of the optical pickup 2, and performs an error correction or the like in the input, and demodulates it into the stereoscopic image signal and the audio signal. In the stereoscopic image, the right eye image and the left eye image respectively having 1080 pixels in the vertical direction and 1920 pixels in the horizontal direction are independently recorded at 24 frames/sec. Accordingly, the reproduced stereoscopic image also becomes an image signal in which the right eye image and the left eye image respectively have 1080 pixels in the vertical direction and 1920 pixels in the horizontal direction at 24 frames/sec.

(1d) Addition of OSD of First Reproducing Device 100

In this manner, the first OSD addition circuit 5 adds the OSD of the first reproducing device 100 to the right eye image and the left eye image of the reproduced stereoscopic image signal, respectively, as necessary. Ac this time, the respective OSD display position of the right eye image and the left eye image are controlled according to the above-described OSD display depth. That is, as described above, a protruding position (depth) of the OSD is determined by superimposing on a position in the right eye image at which the OSD is offset by 32 pixels to the left, and on a position in the left eye image at which the OSD is offset by 32 pixels to the right.

(2) Transmission of Image Signal and Audio Signal

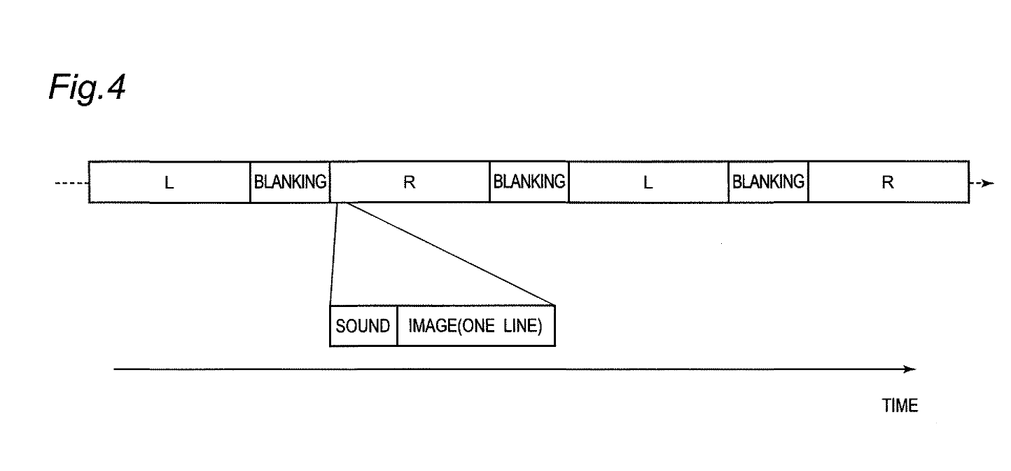

FIG. 4 is a diagram which illustrates a structure of the HDMI signal according to the first embodiment.

The stereoscopic image signal added with the OSD is transmitted to the first HDMI transmission circuit 7, and 2C becomes a signal in which the left eye image and the right eye image are multiplexed in time division, respectively, as illustrated in FIG. 4. Each frame of the left eye image and the right eye image has a line structure, and has a horizontal blanking period at the top of each line. The audio signal is multiplexed in each horizontal blanking period.

In this manner, the signal in which the stereoscopic image and the audio signal are multiplexed is converted to a format suitable for transmission, and is output from the first output terminal 8.

(3) Operation of First Display Device 200

(3a) Reception of Image Signal and Audio Signal by First Display Device 200

The HDMI signal which is input by the first input terminal 201 is received by the first HDMI reception circuit 203, and is demodulated to the original stereoscopic image signal and audio signal. The stereoscopic image signal is sent to the second OSD addition circuit 204.

The audio signal is amplified in the first audio amplifier 210, and is sent to a user through the first speaker 211.

(3B) OSD Addition of First Display Device 200

The right eye image and left eye image of the received stereoscopic image signal are respectively added with the CSD of the first display device 200 as necessary. At this time, the OSD display depth of the right eye image and left eye image are controlled according to the above-described OSD display depth. That is, as described above, in the first display device 200, since “192” is preset as the OSD depth information, the protruding position of the OSD (depth) is determined by superimposing the OSD on the image by offsetting the OSD by 64 pixels to the left for the right eye image, and by 64 pixels to the right for the left eye image.

(3c) Driving of Displaying Panel 206 and Controlling of Stereoscopic Vision Glasses 208

In the first display device 200, the left eye image and the right eye image are sent in time division, and are sequentially displayed in the order of . . . left, right, left, right, . . . on the displaying panel 206. The stereoscopic vision glasses 208 are provided with the liquid crystal shutters which are separated on the left and right, and are able to control transmission and non-transmission of light. The stereoscopic vision glasses 208 is controlled so as to close a right shutter while the displaying panel 206 is outputting the left eye image, and close a left shutter while the displaying panel 206 is outputting the right eye image according to an infrared signal from the glasses control circuit 207. In this manner, only the right eye image is guided to the right eye of a viewer, and only the left eye image is guided to the left eye of the viewer. Accordingly, the viewer is able to view a stereoscopic image.

1-3. Conclusion

The first reproducing device 100 according to the first embodiment is a reproducing device capable of superimposing a reproducing device image (OSD) different from a stereoscopic image onto the stereoscopic image which can be viewed stereoscopically to generate and output a stereoscopic image signal.

The first reproducing device 100 includes: an acquisition unit (first CPU 6) operable to obtain information about device image depth, the device image depth being stereoscopic vision depth that a device (first display device 200) connected to the reproducing device and capable of superimposing a device image different from the stereoscopic image onto the stereoscopic image gives to the device image (OSD) when the device superimposes the device image onto the stereoscopic image; a superimposing unit (first OSD addition circuit 5) operable to give reproducing device image depth to the reproducing device image based on the information about device image depth obtained by the acquisition unit and superimpose the reproducing device image onto the stereoscopic image to generate the stereoscopic image signal; and a transmission unit (first HDMI transmission circuit 7) operable to transmit the stereoscopic image signal to the device.

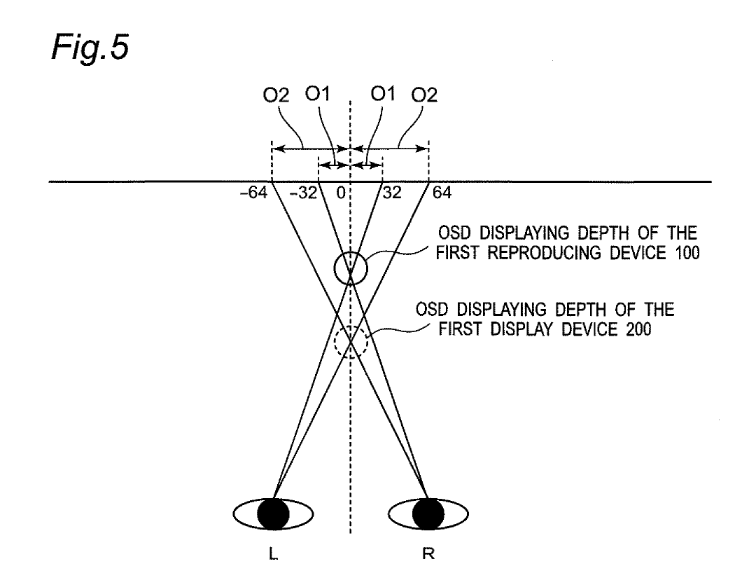

FIG. 5 is a diagram which illustrates each display depth of the plurality of OSDs according to the present embodiment.

As illustrated in FIG. 5, according to the present embodiment, the first reproducing device 100 controls the OSD display depth of the first reproducing device based on the OSD depth information of the first display device 200. In this manner, the OSD of the first reproducing device 100 is displayed so as to be seen behind the OSD of the first display device 200 from a viewer. As a result, it is possible to eliminate malfunction in which the OSD which is overwritten on the image later, and is added thereto is displayed with a sense of depth deeper than the OSD which is overwritten on the image earlier, and is added thereto.

### 2. Second Embodiment

Subsequently, a reproducing device 300, and a display device 400 according to a second embodiment will be described.

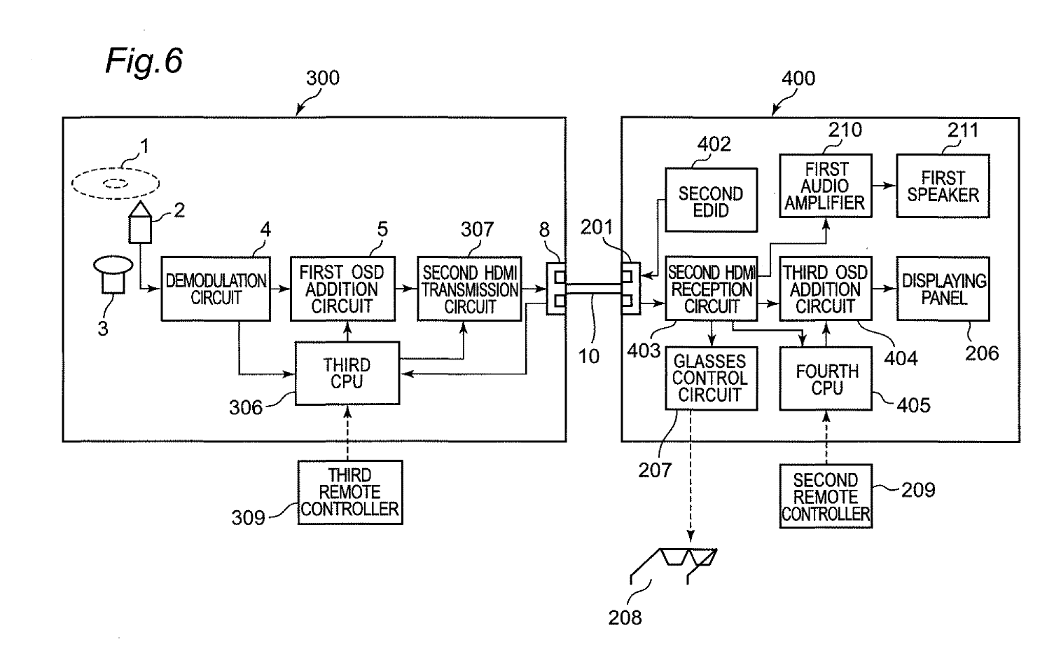

The reproducing device 300, and the display device 400 according to the present embodiment can be industrially produced based on an internal configuration diagram illustrated in FIG. 6.

2-1. Regarding Configuration

FIG. 6 is a block diagram which illustrates internal configurations of the reproducing device 300 and the display device 400 according to the second embodiment. In this figure, the second reproducing device 300 is an image reproducing device capable of reproducing an optical disc 1. The second reproducing device 300 includes an optical pickup 2, a motor 3, a demodulation circuit 4, a first OSD addition circuit 5, a third CPU 306, a second HDMI transmission circuit 307, a first output terminal 8, and a third remote controller 309.

The second display device 400 includes a first input terminal 201, a second EDID 402, a second HDMI reception circuit 403, a third OSD addition circuit 404, a fourth CPU 405, a displaying panel 206, a glasses control circuit 207, stereoscopic vision glasses 208, a second remote controller 209, a first audio amplifier 210, and a first speaker 211. In addition, the first output terminal 8 of the second reproducing device 300 and the first input terminal 201 of the second display device 400 are connected to each other through the first cable 10.

When comparing the configuration illustrated in FIG. 6 to the configuration in FIG. 1, the optical pickup 2, the motor 3, the demodulation circuit 4, the first OSD addition circuit 5, and the first output terminal 8 in the second reproducing device 300 are common to those in the first reproducing device 100 according to the first embodiment. The first CPU 6 is replaced by the third CPU 306, the first HDMI transmission circuit 7 is replaced by the second HDMI transmission circuit 307, and the first remote controller 9 is replaced by the third remote controller 309.

In addition, the first input terminal 201 of the second display device 400, the displaying panel 206, the glasses control circuit 207, the stereoscopic vision glasses 208, the second remote controller 209, the first audio amplifier 210, and the first speaker 211 are common to those in the first display device 200 according to the first embodiment. The first EDID 202 is replaced by the second EDID 402. The first HDMI reception circuit 203 is replaced by the second HDMI reception circuit 403. The second OSD addition circuit 204 is replaced by the third OSD addition circuit 404. The second CPU 205 is replaced by the fourth CPU 405.

The third CPU 306 is a microprocessor which controls the second reproducing device 300. The third CPU 306 controls the first OSD addition circuit 5, and generates OSD information as necessary based on reproducing information which is obtained by operation of a user which is sent from the third remote controller 309 or the demodulation circuit 4. In addition, the third CPU 306 outputs the OSD depth information of the second reproducing device 300 with respect to the second HDMI transmission circuit 307.

The second HDMI transmission circuit 307 adds packet information which is sent from the third CPU 306 to an image blanking period such as a stereoscopic image output of the first CSD addition circuit 5, an audio output of the demodulation circuit 4, or the like, modulates the information to a digital image signal of the HDMI format, and outputs no the second display device 400 through the first output terminal 8.

The third remote controller 309 is operated by a user, and delivers instructions such as reproducing start, stop, information display, or the like to the second reproducing device 300.

Regarding the second display device 400, the second EDID 402 includes a memory element in which information relating to functions which are included in the second display device 400 is stored, and stores the information in a form of a data array determined in the EDID standard of the EIA/CEA 861-D.

The second HDMI reception circuit 403 receives the HDMI signal through the first input terminal 201, and demodulates it into a stereoscopic image, a synchronization signal, audio, and a packet signal.

The third OSD addition circuit 404 overwrites (superimposes) characters, or an image of icon information (OSD) on the respective image signals of the left eye image and the right eye image of the stereoscopic image signal which is output from the second HDMI reception circuit 403, and outputs the signals. In addition, the third OSD addition circuit 404 has a function of changing the OSD display depth of the second display device 400.

The fourth CPU 405 is a microprocessor which controls the first display device 200. The fourth CPU 405 controls the third OSD addition circuit 404, and generates the OSD information according to an instruction from a user which is sent from the second remote controller 209.

2-2. Regarding Operation

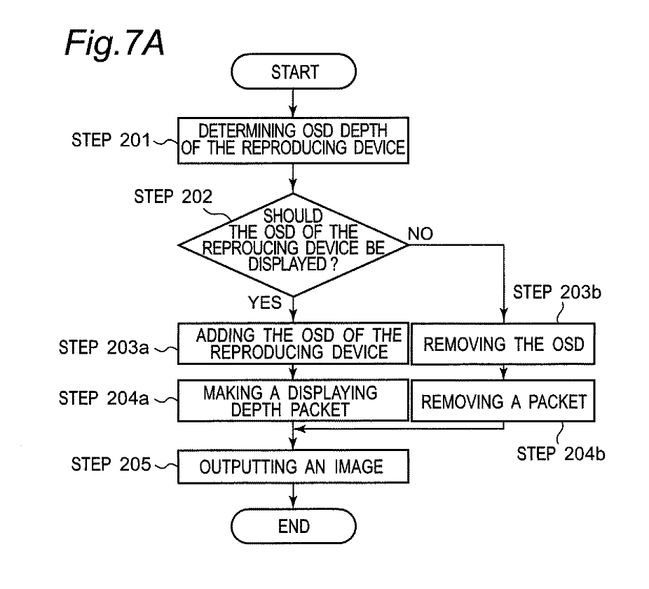

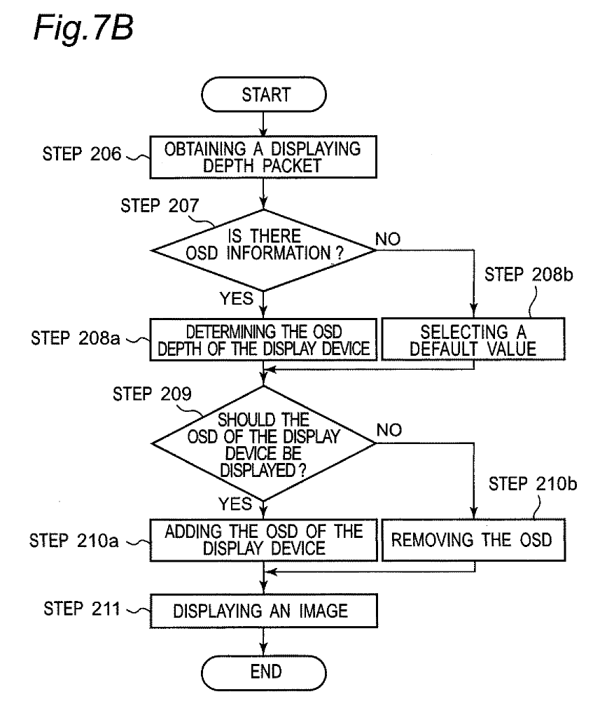

FIGS. 7A and 7B are flowcharts which illustrate operation of the second reproducing device 300 and the second display device 400 according to the second embodiment. Hereinafter, the operation of the second reproducing device 300 and the second display device 400 will be described with reference to the flowcharts.

2-2-a. Summary of Operation of Second Reproducing Device 300 and Second Display Device 400

FIG. 7A is a flowchart relating to operation of the second reproducing device 300. With reference to FIG. 7A, first, in step 201, the second reproducing device 300 determines the OSD display depth of the second reproducing device 300.

Subsequently, in step 202, the second reproducing device 300 determines whether or not to instruct a display of the OSD of the second reproducing device 300. When there is a display instruction, the second reproducing device 300 adds the CSD of the second reproducing device 300 to an image signal in step 203a. When there is no display instruction, the second reproducing device 300 removes (or does not add) the OSD (step 203b).

Further, in step 204a, the second reproducing device 300 makes the OSD information of the second reproducing device 300 as a packet. When there is no display instruction (“NO” in step 202), the second reproducing device 300 removes the OSD, and removes the packet of the OSD information (step 204b).

Subsequently, in step 205, the second reproducing device 300 outputs an image signal to the second display device 400.

When continuously outputting the images, step 202 to step 205 are repeated.

FIG. 73 is a flowchart relating to the operation of the second display device 400. With reference to FIG. 7B, in step 206, the second display device 400 obtains a packet including the OSD depth information of the second reproducing device 300.

Subsequently, in step 207, the second display device 400 determines the presence or absence of the OSD depth information of the second reproducing device 300. Here, when there is the OSD depth information of the second reproducing device 300, the second display device 400 adjusts the OSD depth information of the second display device 400 based on the OSD depth information of the second reproducing device 300 in step 208a. When there is no OSD depth information of the second reproducing device 300, the second display device 400 selects a preset default value as the OSD display depth of the second display device 400 (step 208b).

Subsequently, in step 209, the second display device 400 determines whether or not to instruct a display of the OSD of the second display device 400. When there is a display instruction, the second display device 400 adds the OSD of the second display device 400 to the image signal in step 210a. When there is no display instruction, the second display device 400 removes (or does not add) the OSD (step 210b).

Finally, in step 211, the second display device 400 displays an image on the displaying panel 206.

When continuously displaying images, step 209 to step 211 are repeated.

2-2-b. Detailed Operation of Second Reproducing Device 300 and Second Display Device 400

(1) Operation of Second Reproducing Device 300

(1a) Reading of Second EDID 402 by Third CPU 306

The third CPU 306 of the second reproducing device 300 performs reading of the second EDID 402 of the second display device 400 in the initial state. A non-volatile memory of the second EDID 402 is mainly recorded with information relating to functions which are included in the second display device 400 such as an image format which is prescribed in the EIA/CEA861-D standard, or the like. The third CPU 306 reads the information through a serial transmission path which has passed through the first cable 10, and determined in the VESA/E-DDC standard.

The second reproducing device 300 transmits the image signal and the audio signal in an image format which can be displayed by the second display device 400 according to the information of the second EDID 402.

(1b) Reproducing of Image Signal And Audio Signal

The optical disc 1 is recorded with a stereoscopic image signal and an audio signal which are compressed by the MPEG 4 method. The optical pickup 2 converts signals recorded in the optical disc 1 to electrical signals. The motor 3 rotates the optical disc 1 at suitable speed for reproducing.

The demodulation circuit 4 inputs an output of the optical pickup 2, and performs an error correction or the like in the input, and demodulates it into the stereoscopic image signal and the audio signal. In the stereoscopic image, the right eye image and the left eye image respectively having 1080 pixels in the vertical direction and 1920 pixels in the horizontal direction are independently recorded at 24 frames/sec. Accordingly, the reproduced stereoscopic image also becomes an image signal in which the right eye image and the left eye image respectively have 1080 pixels in the vertical direction and 1920 pixels in the horizontal direction at 24 frames/sec.

(1c) Addition of OSD of Second Reproducing Device 300

In this manner, the first OSD addition circuit 5 adds the OSD of the second reproducing device 300 to the right eye image and the left eye image of the reproduced stereoscopic image signal, respectively, as necessary. At this time, a user is able to change the OSD display depth using the third remote controller 309. That is, when a user delivers an instruction of changing the OSD display depth using the third remote controller 309, the third CPU 306 determines the OSD display depth, for example, in a range of 128 to 192 according to the instruction. The first OSD addition circuit adds the OSD which is added with an offset to the left eye image and the right eye image, respectively, according to the OSD depth information. A relationship between the OSD depth information and the offset amount in the respective left eye image and right eye image is the same as that in Table 1 in the first embodiment.

It is possible to change a protruding amount (depth) from a screen of the OSD of the second reproducing device 300 by changing the offset amount from 128 to 192. A user (viewer) is able to select an OSD display position which is easy to view for the user.

In addition, the third CPU 306 sends the OSD depth information of the second reproducing device 300 which is determined in this manner to the second HDMI transmission circuit 307.

Hereinafter, in descriptions according to the present embodiment, it is assumed that a user sets the offset amount to “140”.

(2) Transmission of Image Signal and Audio Signal

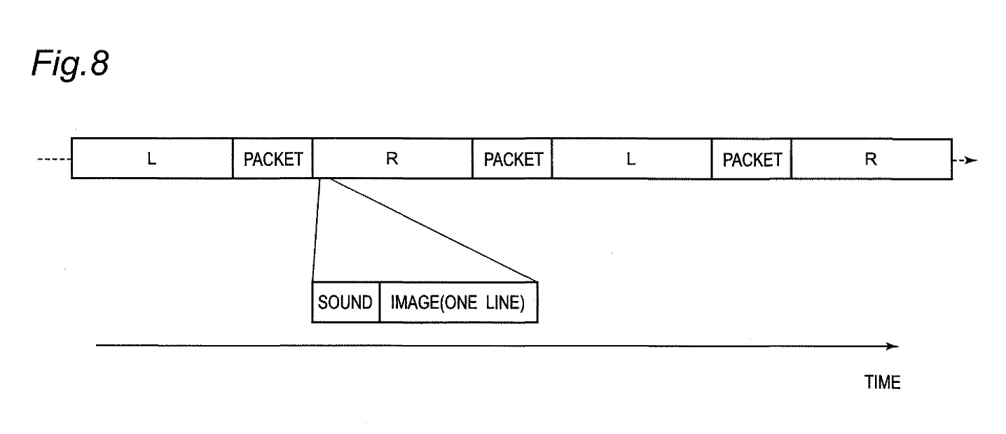

FIG. 8 is a diagram which illustrates a structure of the HDMI signal according to the second embodiment.

The stereoscopic image signal to which the OSD is added is sent to the second HDMI transmission circuit 307, and becomes a signal in which the left eye image and right eye image are multiplexed in time division, respectively, as illustrated in FIG. 8. Each frame of the left eye image and right eye image has a line structure, and has a horizontal blanking period at the top of each line. The audio signal is multiplexed in the horizontal blanking period. In addition, the second HDMI transmission circuit 307 makes the OSD depth information which has been sent from the third CPU 306, that is, the value “140” as a packet, and multiplexes the depth information in the blanking between the left eye image and right eye image of the stereoscopic image signal. The stereoscopic image signal becomes the signal illustrated in FIG. 8, is converted to a form which is suitable for transmission, and is output through the first output terminal 8.

(3) Operation of Second Display Device 400

(3a) Reception of Image Signal and Audio Signal Using Second Display Device 400

The HDMI signal which is input from the first input terminal 201 is received by the second HDMI reception circuit 403, and is demodulated to the original stereoscopic image signal, the audio signal, and the packet signal. The stereoscopic image signal is sent to the third OSD addition circuit 404.

The audio signal is amplified in the first audio amplifier 210, and is delivered to a user through the first speaker 211.

(3b) Determination of OSD Display Depth of Second Display Device 400

A fourth CPU 405 illustrated in FIG. 6 determines the OSD display depth of The second display device 400 based on the OSD depth information which is sent from the second HDMI reception circuit 403 according to the flowchart in FIG. 7B, and the value “140”.

That is, the fourth CPU 405 determines the OSD display depth of the device itself so that the OSD of the second display device 400 is not located deeper than (behind) (so as to be located shallower than (in front of)) the OSD of the second reproducing device 300.

Since the OSD depth information of the second reproducing device 300 which is sent from the second HDMI reception circuit 403 is “140”, an OSD offset of the second reproducing device 300 becomes 140−128=+12. Accordingly, the OSD of the second reproducing device 300 is given with an offset of 12 pixels, and is displayed so as to be seen in front of the screen for a viewer.

Here, the fourth CPU 405 selects, for example, “200” which is larger than “140” as the OSD depth information of the second display device 400. In this manner, an OSD offset of the second display device 400 becomes 200−128=+72. Accordingly, the OSD of the second display device 400 is given with an offset of 72 pixels, and is displayed so as to be seen in front of the OSD of the second reproducing device 300 for a viewer.

(3c) Addition of OSD of Second Display Device 400

The OSD of the second display device 400 is added to the respective right eye image and left eye image of the received stereoscopic image signal as necessary. At this time, the OSD display depth of the right eye image and left eye image is controlled according to the above-described OSD depth information. Than is, as described above, since “200” is set as the OSD depth information in the second display device 400, a protruding position of the OSD (depth) is determined by superimposing the OSD on the image by offsetting the OSD by 72 pixels to the left for the right eye image, and by 72 pixels to the right for the left eye image.

(3d) Driving of Displaying Panel 206 and Controlling of Stereoscopic Vision Glasses 208

In the second display device 400, the left eye image and the right eye image are sent in time division, and are sequentially displayed in the order of . . . left, right, left, right, . . . on the displaying panel 206. The stereoscopic vision glasses 208 are provided with the liquid crystal shutters which are separated on the left and right, and are able to control transmission and non-transmission of light. The stereoscopic vision glasses 208 control the stereoscopic vision glasses 208 so as to close a right shutter while the displaying panel 206 is outputting the left eye image, and close a left shutter while the displaying panel 206 is outputting the right eye image according to an infrared signal from the glasses control circuit 207. In this manner, only the right eye image is guided to the right eye of a viewer (user), and only the left eye image is guided to the left eye thereof. Accordingly, the viewer is able to view a stereoscopic image.

2-3. Conclusion

The second display device 400 according to the second embodiment is a display device capable of superimposing a display device image (OSD) being an image different from a stereoscopic image onto the stereoscopic image which can be viewed stereoscopically to display the stereoscopic image.

The second display device 400 includes: a reception unit (second HDMI reception circuit 403) operable to receive a first stereoscopic image signal including the stereoscopic image; an acquisition unit (fourth CPU 405) operable to obtain information about device image depth, the device image depth being stereoscopic vision depth that a device (second reproducing device 300) connected to the display device and capable of superimposing a device image (OSD) being an image different from the stereoscopic image onto the stereoscopic image to output the first stereoscopic image signal gives to the device image when the device superimposes the device image onto the stereoscopic image; a superimposing unit (third OSD addition circuit 404) operable to give display device image depth to the display device image based on the information about device image depth obtained by the acquisition unit and superimpose the display device image onto the stereoscopic image to generate a second stereoscopic image signal; and a display unit (displaying panel 206) operable to display an image based on the second stereoscopic image signal.

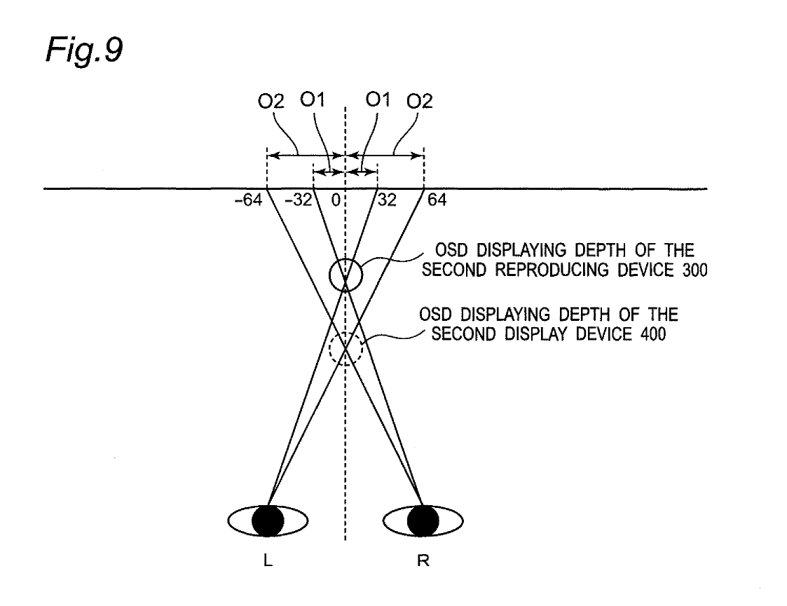

FIG. 9 is a diagram which illustrates each display depth of the plurality of OSDs according to the present embodiment.

As illustrated in FIG. 9, according to the present embodiment, the second display device 400 controls the OSD display depth of the second display device 400 based on the OSD depth information of the second reproducing device 300. Due to this, the OSD of the second reproducing device 300 is displayed so as to be seen behind the OSD of the second display device 400 from a viewer. As a result, it is possible to eliminate malfunction in which the OSD which is overwritten on the image later, and is added thereto is displayed with a sense of depth deeper than the OSD which is overwritten on the image earlier, and is added thereto.

### 3. Third Embodiment

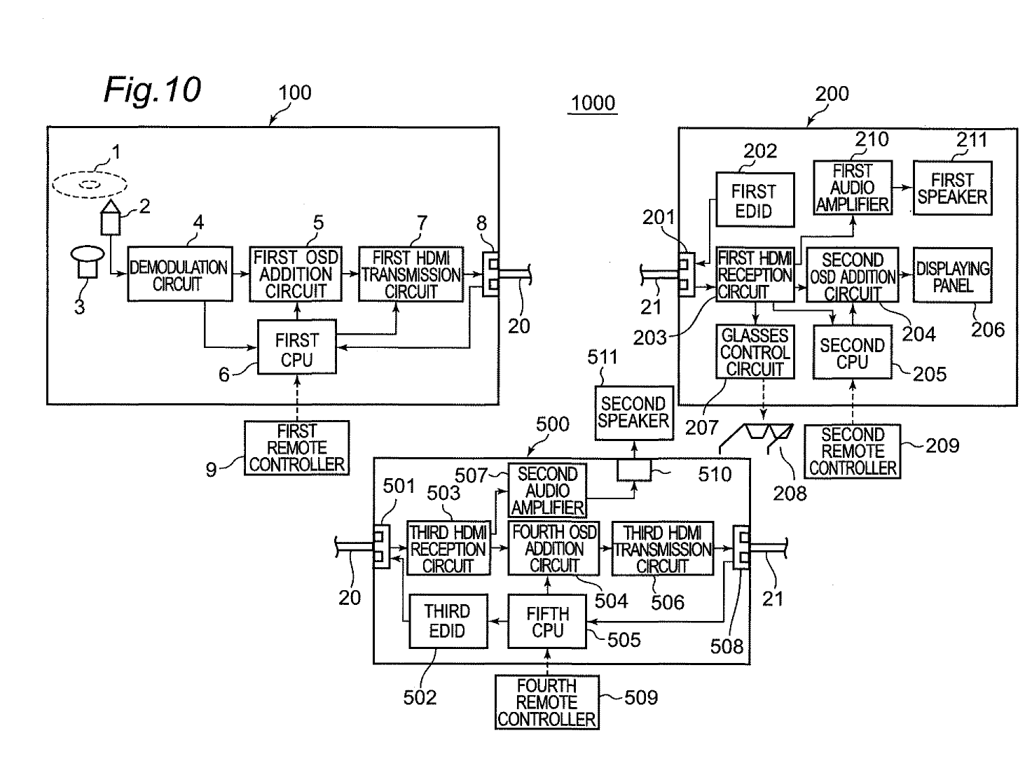

Hereinafter, a video system according to a third embodiment will be described. The video system according to the present embodiment can be industrially produced based on an internal configuration diagram illustrated in FIG. 10.

3-1. Regarding Configuration

FIG. 10 is a block diagram which illustrates an internal configuration of a video system 1000 according to the third embodiment. The video system 1000 according to the present embodiment includes a first reproducing device 100, a first amplification device 500, and a first display device 200. In this figure, the first reproducing device 100 is an image reproducing device capable of reproducing an optical disc 1. The first reproducing device 100 includes an optical pickup 2, a motor 3, a demodulation circuit 4, a first OSD addition circuit 5, a first CPU 6, a first HDMI transmission circuit 7, a first output terminal 8, and a first remote controller 9.

The first display device 200 includes a first input terminal 201, a first EDID 202, a first HDMI reception circuit 203, a second OSD addition circuit 204, a second CPU 205, a displaying panel 206, a glasses control circuit 207, stereoscopic vision glasses 208, a second remote controller 209, a first audio amplifier 210, and a first speaker 211.

The first amplification device 500 includes a second input terminal 501, a third EDID 502, a third HDMI reception circuit 503, a fourth OSD addition circuit 504, a fifth CPU 505, a third HDMI transmission circuit 506, a second audio amplifier 507, a second output terminal 508, a fourth remote controller 509, and an audio output terminal 510.

In addition, the first output terminal 8 of the first reproducing device 100, and the second input terminal 501 of the first amplification device 500 are connected to each other through a second cable 20. The second output terminal 508 of the first amplification circuit 500, and the first input terminal 201 of the first display device 200 are connected to each other through a third cable 21. Further, the audio output terminal 510 of the first amplification device 500 is connected with a second speaker 511.

When comparing a configuration illustrated in FIG. 10 the configuration in FIG. 1, the first reproducing device 100 and the first display device 200 have the same configuration as the first reproducing device 100 and the first display device 200 according to the first embodiment. The present embodiment is different from the first embodiment in that the first amplification device 500 is added, and the first reproducing device 100, the first display device 200, and the first amplification device 500 configures the video system 1000.

Regarding the first amplification device 500, the second input terminal 501 is a video-audio input terminal which conforms to the HDMI standard, and includes a serial transmission path for mutual communication which is prescribed in both the VESA/E-DDC and EIA/CEA861-D standards, along with a video-audio signal transmission path which is digitally modulated therein.

The third EDID 502 includes a memory element in which information relating to functions which are included in the first amplification device 500 is stored, and stores the information in a form of a data array determined in the EDID standard of the EIA/CEA 861-D. The memory element is able to rewrite data. The third EDID 502 further stores information (OSD depth information) indicating the OSD display depth of the first amplification device 500.

The third HDMI reception circuit 503 receives an HDMI signal through the second input terminal 501, and demodulates it into a stereoscopic image signal, a synchronization signal, and an audio signal.

The fourth OSD addition circuit 504 overwrites (superimposes) characters, or an image of icon information (OSD) on the respective image signals of the left eye image and the right eye image of the stereoscopic image signal which is output from the third HDMI reception circuit 503, and outputs the signals. In addition, the fourth OSD addition circuit 504 has a function of changing the OSD display depth of the first amplification device 500.

The fifth CPU 505 is a microprocessor which controls the first amplification device 500. The fifth CPU 505 controls the fourth OSD addition circuit 504, and generates the OSD information according to an instruction from a user which is sent from the fourth remote controller 509.

The third HDMI transmission circuit 506 demodulates a stereoscopic image output of the fourth OSD addition circuit 504 to a digital image signal of an HDMI format, and outputs the signal to the first display device 200 from the second output terminal 508.

The second audio amplifier 507 amplifies an audio signal which is received from the third HDMI reception circuit 503, and outputs the signal to the audio output terminal 510.

The second output terminal 508 is a video-audio output terminal which conforms to the HDMI standard, and includes a serial transmission path for mutual communication which is prescribed in both the VESA/E-DDC and EIA/CEA861-D standards, along with a video-audio signal transmission path which is digitally modulated therein.

The fourth remote controller 509 is operated by a user, and delivers instructions such as reproducing start, stop, information display, or the like to the first reproducing device 100.

The audio output terminal 510 is a terminal which outputs an output to the second audio amplifier 507. The second speaker 511 converts a signal which is output from the first audio output terminal 510 to audio.

The second cable 20 is a signal transmission cable which conforms to the HDMI standard. The third cable 21 is a signal transmission cable which conforms to the HDMI standard.

3-2. Regarding Operation

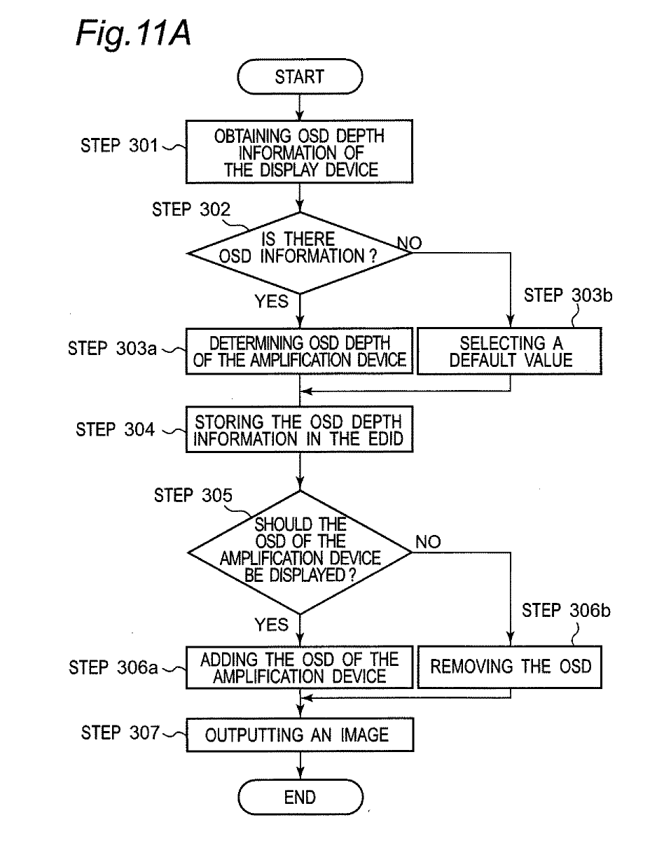

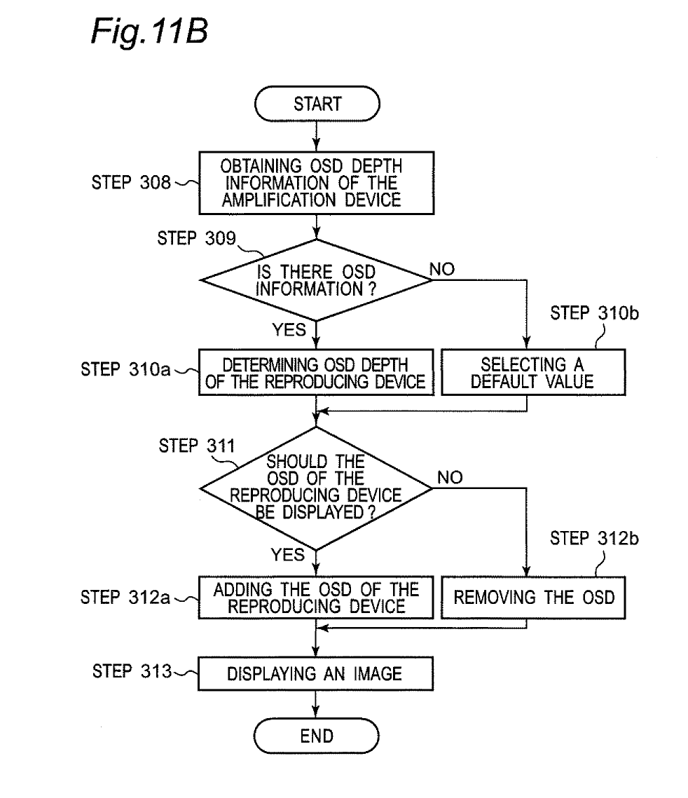

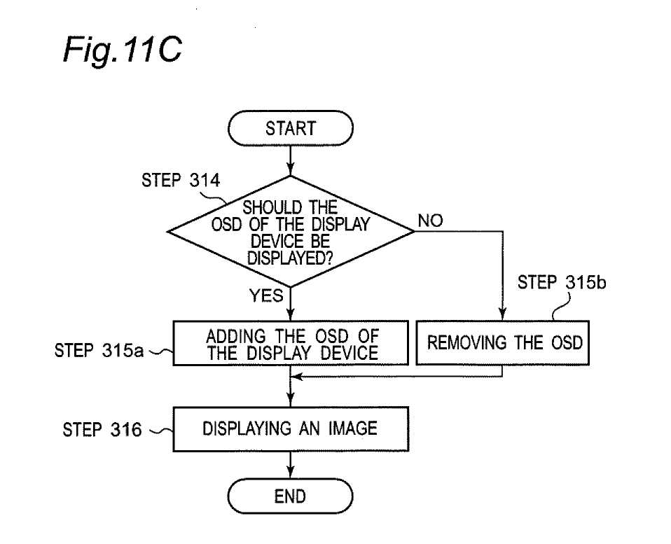

FIGS. 11A, 11B, and 11C are flowcharts which illustrate operation of the video system 1000 (first reproducing device 100, first amplification device 500, and first display device 200) according to the third embodiment. Hereinafter, operation of the first reproducing device 100, the first amplification device 500, and the first display device 200 will be described with reference to the flowcharts.

3-2-a. Summary of Operation of Video System 1000

FIG. 11A is a flowchart relating to the operation of first amplification device 500. With reference to FIG. 11A, first, the first amplification device 500 obtains the OSD depth information of the first display device 200 in step 301.

Subsequently, in step 302, the first amplification device 500 determines the presence or absence of the OSD depth information of the first display device 200. Here, when there is the OSD depth information of the first display device 200, the first amplification device 500 adjusts the OSD depth of the first amplification device 500 based on the OSD depth information of the first display device 200 in step 303a. In step 302, when there is no OSD depth information of the first display device 200, the first amplification device 500 selects a preset default value as the OSD display depth of the first amplification device 500 (step 303b).

Subsequently, in step 304, the first amplification device 500 stores the OSD depth information of the first amplification device 500 in the third EDID 502 of the first amplification device 500. In step 302, when there is no OSD depth information of the first display device 200, the first amplification device 500 selects the preset default value as the OSD depth information of the first amplification device 500, and stores the value in the third EDID 502.

Subsequently, in step 305, the first amplification device 500 determines whether or not to instruct a display of the OSD of the first amplification device 500. Here, when there is a display instruction, the OSD of the first amplification device 500 is added to an image signal in step 306a. When there is no display instruction, the first amplification device 500 removes (or does not add) the OSD (step 306b).

Subsequently, in step 307, the first amplification device 500 outputs the image signal to the first display device 200.

When continuously outputting images, step 305 to step 307 are repeated.

FIG. 11B is a flowchart relating to operation of the first reproducing device 100. With reference to FIG. 11B, the first reproducing device 100 obtains the OSD depth information of the first amplification device 500 in step 308.

Subsequently, in step 309, the first reproducing device 100 determines the presence or absence of the OSD depth information of the first amplification device 500. Here, when there is the OSD depth information of the first amplification device 500, the first reproducing device 100 adjusts the OSD depth of the first reproducing device 100 based on the OSD depth information of the first amplification device 500 in step 310a. In step 309, when there is no CSD depth information of the first amplification device 500, the first reproducing device 100 selects a preset default value as the OSD depth information of the first reproducing device 100 (step 310b).

Subsequently, in step 311, the first reproducing device 100 determines whether or not to instruct a display of the OSD of the first reproducing device 100. Here, when there is a display instruction, the first reproducing device 100 adds the OSD of the first reproducing device 100 to an image signal in step 312a. When there is no display instruction, the first reproducing device 100 removes (or does not add) the OSD (step 312b).

Subsequently, in step 313, the first reproducing device 100 outputs an image signal to the first amplification device 500.

When continuously outputting images, step 311 to step 313 are repeated.

FIG. 11C is a flowchart relating to operation of the first display device 200. With reference to FIG. 11C, subsequently, in step 314, the first display device 200 determines whether or not to instruct a display of the OSD of the first display device 200. When there is a display instruction, the first display device 200 adds the OSD of the first display device 200 to an image signal in step 315a. When there is no display instruction, the first display device 20C removes (or does not add) the OSD (step 315b).

Finally, in step 316, the first display device 200 displays an image on the displaying panel 206.

When continuously displaying images, step 314 to step 316 are repeated.

3-2-b. Detailed Operation of Video System 1000

(1) Determining OSD Display Depth of Device Itself by First Amplification Device 500

(1a) Reading of First EDID 202 by Fifth CPU 505

The fifth CPU 505 of the first amplification device 500 performs reading of the first EDID 202 of the first display device 200 in step 301. The first EDID 202 is a non-volatile memory, and here, in the first EDID 202, information mainly relating to functions included in the first display device 200 such as an image format or the like which is prescribed in the EIA/CEA861-D standard is stored, and the OSD depth information of the first display device 200 is recorded along with the information. The fifth CPU 505 reads the OSD depth information of the first display device 200 through a serial transmission path which has passed through the third cable 21 and determined in the VESA/E-DDC standard.

(1b) Determining OSD Display Position of First Amplification Device 500

The fifth CPU 505 of the first amplification device 500 illustrated in FIG. 10 reads the OSD depth information of the first display device 200 which is recorded in the first EDID 202 according to the flowchart illustrated in FIG. 11A, and determines the OSD display depth of the first amplification device 500 according to the value.

That is, the fifth CPU 505 determines the OSD display depth of device itself so that the OSD of the first amplification device 500 is not located in front of (so as to be located behind) the OSD of the first display device 200.

Here, a relationship between the OSD display depth and the offset amount in the respective left eye image and right eye image of the CSD is as illustrated in Table 1 in the first embodiment.

For example, when a value of the OSD depth information which is stored in the first EDID 202 of the first display device 200 is “192”, an OSD offset of the first display device 200 becomes 192−128=−64. Accordingly, the OSD of the first display device 200 is given with the offset of 64 pixels, and is displayed so as to be seen in front of the screen for a viewer.

Here, the fifth CPU 505 selects, for example, “176” which is smaller than “192” as the OSD depth information of the first amplification device 500. In this manner, an OSD offset of the first amplification device 500 becomes 176−128=+48. Accordingly, the OSD of the first amplification device 500 is given with the offset of 48 pixels, and is displayed so as to be seen behind the OSD of the first display device from a viewer.

(1c) Writing of Third EDID 502 of First Amplification Device 500

Further, the fifth CPU 505 stores information relating to an image signal format which is read from the first EDID 202, and can be received by the first display device 200, information relating to an audio signal format which can be received by the first amplification device 500, and the OSD depth information of the first amplification device 500, that is, the value “176” in the third EDID 502.

(2) Operation of First Reproducing Device 100

(2a) Reading Third EDID 502 of First Amplification Device 500

The first CPU 6 of the first reproducing device 100 performs reading of the third EDID 502 of the first amplification device 500 in step 308. The third EDID 502 is recorded with information relating to the image format which can be received by the first display device 200, information relating to the audio format which can be received by the first amplification device 500, and the OSD depth information of the first amplification device 500, that is, the value “176”. The first CPU 6 reads information relating to the image format which can be received by the first display device 200, information relating to the audio format which can be received by the first amplification device 500, the OSD depth information of the first amplification device 500 through a serial transmission path which has passed through the second cable 20 and determined in the VESA/E-DDC standard.

The first reproducing device 100 transmits a stereoscopic image signal in a form of an image format which can be displayed by the first display device 200, and an audio signal in a form of an audio format which can be amplified by the first amplification device 500 according to information of the third EDID 502.

(2b) Determining OSD Display Depth of First Reproducing Device 100

The first CPU 6 of the first reproducing device 100 illustrated in FIG. 10 reads the OSD depth information of the first amplification device 500 which is recorded in the third EDID 502, and determines the OSD display depth of the first reproducing device 100 according to the value following the flowchart illustrated in FIG. 11B.

That is, the first CPU 6 determines the OSD display depth of the device itself so that the OSD of the first reproducing device 100 is not located in front of (so as to be located farther behind) the OSD of the first amplification device 500.

As described above, when the value of the first amplification device 500 which is stored in the third EDID 502 is “176”, an OSD offset of the first amplification device 500 becomes 176−128=+48. Accordingly, the OSD of the first amplification device 500 is given with the offset of 48 pixels, and is displayed so as to be seen in front of the screen.

Here, the first CPU 6 selects, for example, “160” which is smaller than “176” as the OSD depth information of the first reproducing device 100. In this manner, an OSD offset of the first reproducing device 100 becomes 160−128−=+32. Accordingly, the OSD of the first reproducing device 100 is given with the offset of 32 pixels, and is displayed so as to be seen behind the OSD of the first amplification device 500 from a viewer.

(2c) Reproducing of Image Signal and Audio Signal

The optical disc 1 is recorded with the stereoscopic image signal and the audio signal which are compressed by the MPEG 4 method. The optical pickup 2 converts the signal which is recorded in the optical disc 1 to the electrical signal. The motor 3 is rotated at a speed which is suitable for reproducing the optical disc 1.

The demodulation circuit 4 inputs an output of the optical pickup 2, performs the error correction in the input, and demodulates it into the stereoscopic image signal and the audio signal. In the stereoscopic image, the right eye image and the left eye image respectively having 1080 pixels in the vertical direction and 1920 pixels in the horizontal direction are independently recorded at 24 frames/sec. Accordingly, the reproduced stereoscopic image also becomes an image signal in which the right eye image and the left eye image respectively have 1080 pixels in the vertical direction and 1920 pixels in the horizontal direction at 24 frames/sec.

(2d) Addition of OSD of First Reproducing Device 100

In this manner, the first OSD addition circuit 5 adds the OSD of the first reproducing device 100 to the respective right eye image and left eye image of the reproduced stereoscopic image signal as necessary. At this time, the respective OSD display positions of the right eye image and left eye image are controlled according to the above-described OSD depth position. That is, as described above, a protruding position of the OSD (depth) is determined by superimposing on a position at which the OSD is offset by 32 pixels to the left in the right eye image, and the OSD is offset by 32 pixels to the right in the left eye image.

(3) Transmission of Image Signal and Audio Signal

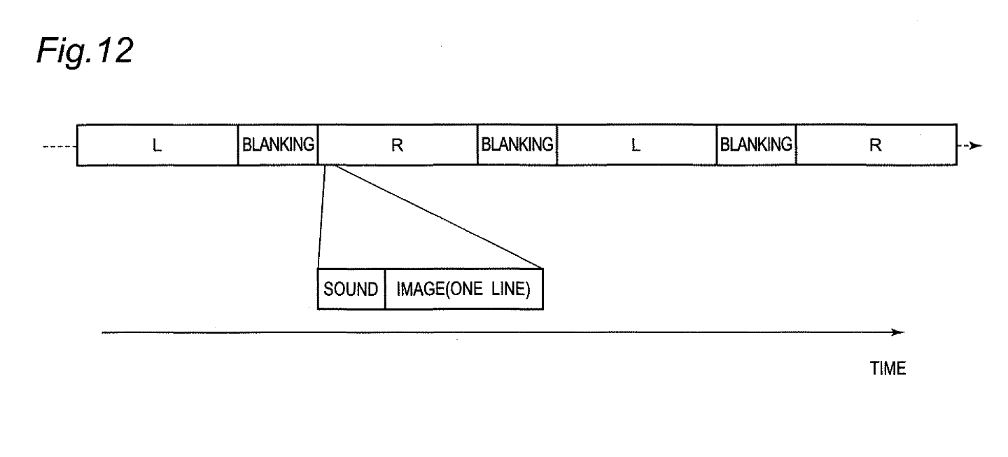

FIG. 12 is a diagram which illustrates a structure of an HDMI signal output of the first reproducing device 100 according to the third embodiment.

The stereoscopic image signal added with the OSD is transmitted to the first HDMI transmission circuit 7, and becomes a signal in which the left eye image and the right eye image are respectively multiplexed in time division, as illustrated in FIG. 12. Each frame of the left eye image and the right eye image has a line structure, and the top of each line has a horizontal blanking period. The audio signal is multiplexed in each of the horizontal blanking periods.

In this manner, the signal in which the stereoscopic image and the audio signal are multiplexed is converted to a format suitable for transmission, and is output from the first output terminal 8.

(4) Operation of First Amplification Device 500

(4a) Reception of Image Signal and Audio Signal of Display Device

The HDMI signal which is input from the second input terminal 501 is received by the third HDMI reception circuit 503, and is demodulated to the original stereoscopic image signal and the audio signal. The stereoscopic image signal is transmitted to the fourth OSD addition circuit 504.

The audio signal is amplified in the second audio amplifier 507, and is output from the audio output terminal 510.

The second speaker 511 is connected to the audio output terminal 510, and a signal which is output from the audio output terminal 510 is delivered to a user by being converted to audio.

(4b) Addition of OSD of First Amplification Device 500

The OSD of the amplification device 500 is added to the respective right eye image and left eye image of the received stereoscopic image signal as necessary. At this time, the OSD display depth of the right eye image and left eye image is controlled according to the above-described OSD depth information. That is, as described above, since “176” is preset as the OSD depth information in the first amplification device 500, a protruding position of the OSD (depth) is determined by superimposing the OSD on the image by offsetting the OSD by 48 pixels to the left for the right eye image, and by 48 pixels to the right for the left eye image.

(5) Transmission of Image Signal

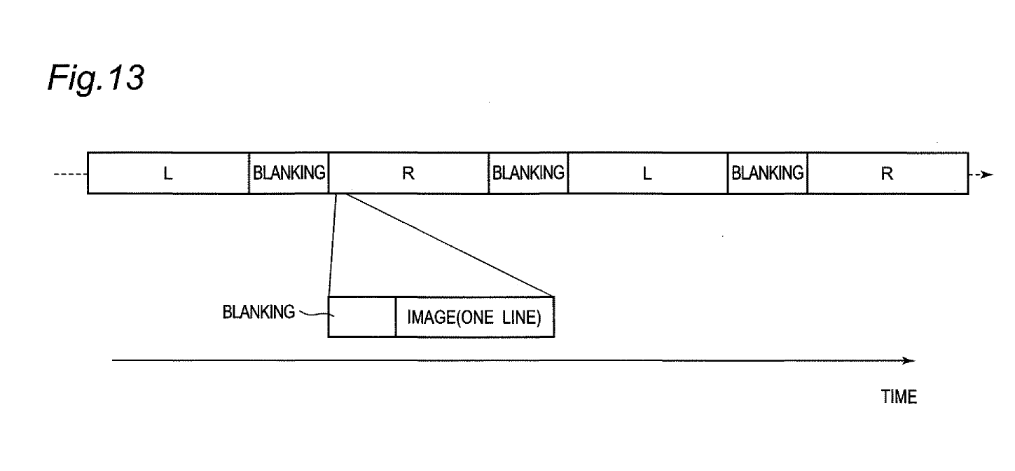

FIG. 13 is a diagram which illustrates an output structure of the HDMI signal of the first amplification device 500 according to the third embodiment.

The stereoscopic image signal to which the OSD is attached is transmitted to the third HDMI transmission circuit 506, and becomes a signal in which the respective left eye image and right eye image are multiplexed in time division, as illustrated in FIG. 13. Each frame of the left eye image and the right eye image has a line structure, and the top of each line has a horizontal blanking period. In this manner, the stereoscopic image signal is output from the second output terminal 508 by being converted to a format suitable for transmission.

(6) Operation of First Display Device 200

(6a) Reception of Image Signal by First Display Device 200

The HDMI signal which is input by the first input terminal 201 is received by the first HDMI reception circuit 203, and is demodulated to the original stereoscopic image signal. The stereoscopic image signal is sent to the second CSD addition circuit 204.

(6b) Addition of OSD by First Display Device 200

The OSD of the display device 200 is added to the respective right eye image and left eye image of the received stereoscopic image signal as necessary. At this time, the OSD display depth of the right eye image and the left eye image is controlled according to the above-described OSD depth information. That is, as described above, since “192” is preset as the OSD depth information in the first display device 200, a protruding position of the OSD (depth) is determined by superimposing the OSD on the image by offsetting the OSD by 64 pixels to the left for the right eye image, and by 64 pixels to the right for the left eye image.

(6c) Driving of Displaying Panel 206 and Controlling of Stereoscopic Vision Glasses 208

In the first display device 200, the left eye image and the right eye image are sent in time division, and are sequentially displayed in the order of . . . left, right, left, right, . . . on the displaying panel 206. The stereoscopic vision glasses 208 are provided with the liquid crystal shutters which are separated on the left and right, and are able to control transmission and non-transmission of light. The stereoscopic vision glasses 208 control the stereoscopic vision glasses 208 so as to close a right shutter while the displaying panel 206 is outputting the left eye image, and close a left shutter while the displaying panel 206 is outputting the right eye image according to an infrared signal from the glasses control circuit 207. In this manner, only the right eye image is guided to the right eye of a viewer, and only the left eye image is guided to the left eye thereof. Accordingly, the viewer is able to view a stereoscopic image.

3-3. Conclusion

The first amplification device 500 according to the third embodiment is an amplification device capable of receiving a first stereoscopic image signal including a stereoscopic image which can be viewed stereoscopically from first reproducing device 100 and superimposing an amplification device image (OSD) being an image different from the stereoscopic image onto the stereoscopic image to generate and transmit a second stereoscopic image signal to a first display device 200.

The first amplification device 500 includes: a reception unit (third HDMI reception circuit 503) operable to receive the first stereoscopic image signal; an acquisition unit (fifth CPU 505) operable to obtain information about display device image depth, the display device image depth being stereoscopic vision depth that the first display device 200 capable of superimposing a display device image (OSD) being an image different from the stereoscopic image onto the stereoscopic image gives to the display device image when the display device superimposes the display device image onto the stereoscopic image; a superimposing unit (fourth OSD addition circuit 504) operable to give amplification device image depth to the amplification device image based on the information about display device image depth obtained by the acquisition unit and superimpose the amplification device image onto the stereoscopic image to generate a second stereoscopic image signal; and a transmission unit (third HDMI transmission circuit 506) operable to transmit the second stereoscopic image signal to the first display device 200.

The video system 1000 according to the third embodiment is a video system including a first reproducing device 100, a first display device 200, and a first amplification device 500.

The first reproducing device 100 is a reproducing device capable of superimposing a reproducing device image (OSD) being an image different from a stereoscopic image onto the stereoscopic image which can be viewed stereoscopically to generate and output a first stereoscopic image signal. The first reproducing device 100 includes: an acquisition unit (first CPU 6) operable to obtain information about amplification device image depth, the amplification device image depth being stereoscopic vision depth that the first amplification device 500 connected to the reproducing device and capable of superimposing a amplification device image (OSD) being an image different from the stereoscopic image onto the stereoscopic image gives to the amplification device image when the amplification device superimposes the amplification device image onto the stereoscopic image; a superimposing unit (first OSD addition circuit 5) operable to give reproducing device image depth to the reproducing device image based on the information about amplification device image depth obtained by the acquisition unit and superimpose the reproducing device image onto the stereoscopic image to generate the first stereoscopic image signal; and a transmission unit (first HDMI transmission circuit 7) operable to transmit the first stereoscopic image signal to the first amplification device 500.

The first amplification device 500 is an amplification device capable of receiving the first stereoscopic image signal from the first reproducing device 100 and superimposing the amplification device image being an image different from the stereoscopic image onto the stereoscopic image to generate and transmit a second stereoscopic image signal to a first display device 200. The first amplification device 500 includes: a reception unit (third HDMI reception circuit 503) operable to receive the first stereoscopic image signal; an acquisition unit (fifth CPU 505) operable to obtain information about display device image depth, the display device image depth being stereoscopic vision depth that the first display device 200 capable of superimposing a display device image (OSD) being an image different from the stereoscopic image onto the stereoscopic image gives to the display device image when the display device superimposes the display device image onto the stereoscopic image; a superimposing unit (fourth OSD addition circuit 504) operable to give the amplification device image depth to the amplification device image based on the information about display device image depth obtained by the acquisition unit and superimpose the amplification device image onto the stereoscopic image to generate the second stereoscopic image signal; and a transmission unit (third HDMI transmission circuit 506) operable to transmit the second stereoscopic image signal to the first display device 200.

The first display device 200 is a display device capable of receiving the second stereoscopic image signal from the first amplification device 500 and superimposing the display device image being an image different from the stereoscopic image onto the stereoscopic image to display the stereoscopic image. The first display device 200 includes: a reception unit (first HDMI reception circuit 203) operable to receive the second stereoscopic image signal; a superimposing unit (second OSD addition circuit 204) operable to give the display device image depth to the display device image and superimpose the display device image onto the stereoscopic image to generate a third stereoscopic image signal; and a display unit (displaying panel 206) operable to display an image based on the third stereoscopic image signal.

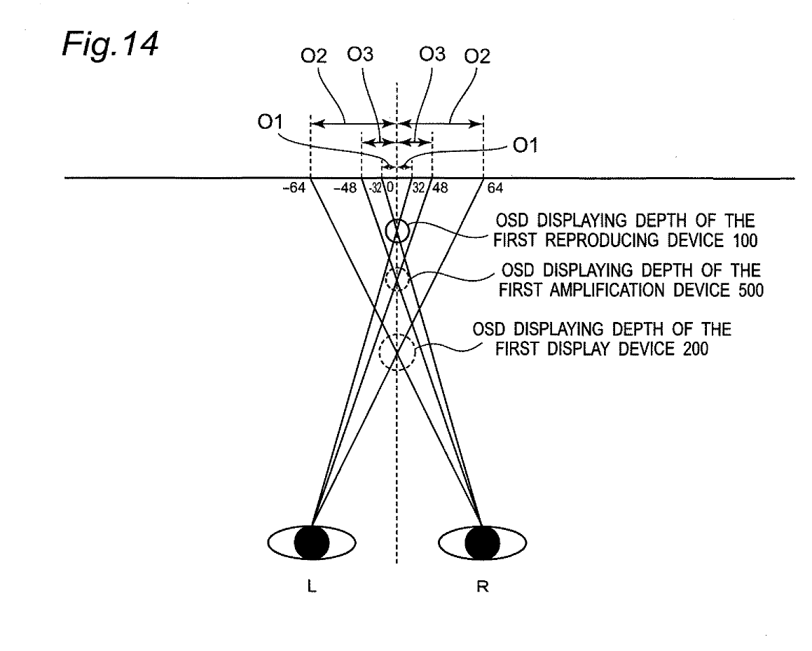

FIG. 14 is a diagram which illustrates each display depth of the plurality of OSDs according to the present embodiment.

As illustrated in FIG. 14, according to the present embodiment, the first amplification device 500 controls the OSD display depth of the first amplification device 500 based on the OSD depth information of the first display device 200. In addition, the first reproducing device 100 controls the OSD display depth of the first reproducing device 100 based on the OSD depth information of the first amplification device 500. Due to this, as illustrated in FIG. 14, the OSD of the first reproducing device 100 is displayed so as to be seen behind the OSD of the first amplification device 500 from a viewer. In addition, the OSD of the first amplification device 500 is displayed so as to be seen behind the first display device 200 from a viewer. As a result, it is possible to eliminate the malfunction in which the OSD which is overwritten on the image later, and is added thereto is displayed with the sense of depth deeper than the OSD which is overwritten on the image earlier, and is added thereto.

### 4. Fourth Embodiment

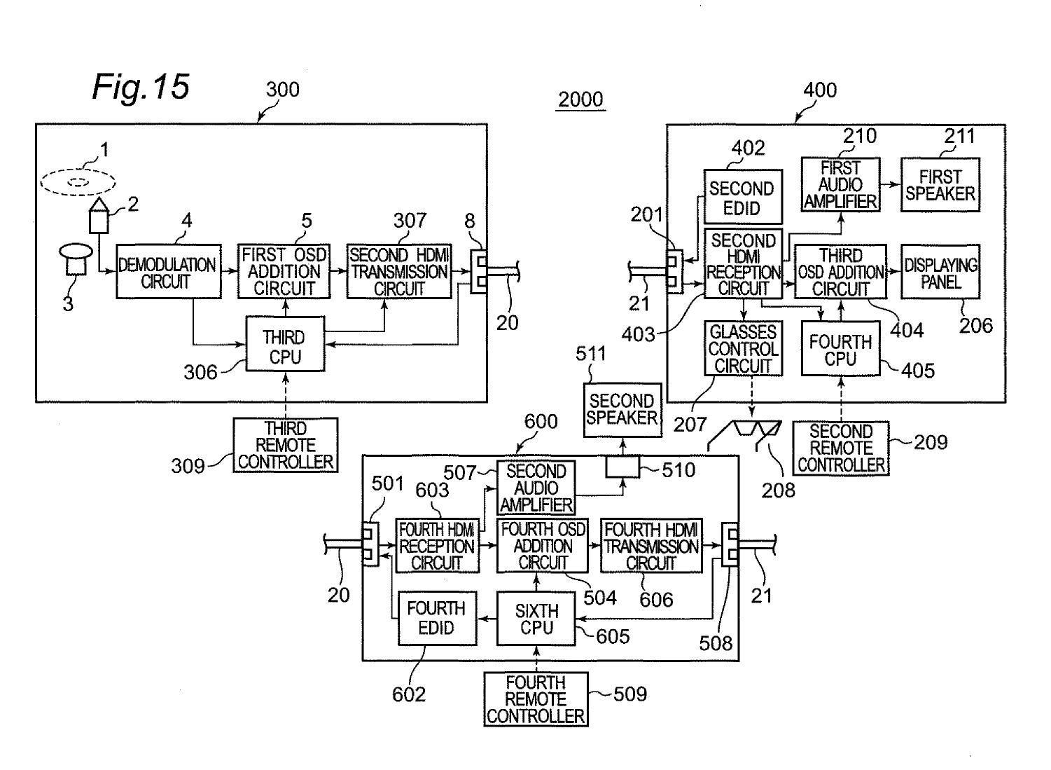

Hereinafter, a video system according to a fourth embodiment will be described. The video system according to the present embodiment can be industrially produced based on an internal configuration diagram illustrated in FIG. 15.

4-1. Regarding Configuration

FIG. 15 is a block diagram which illustrates an internal configuration of a video system 2000 according to a fourth embodiment. The video system 2000 according to the present embodiment includes a second reproducing device 300, a second amplification device 600, and a second display device 400. In this figure, the second reproducing device 300 is an image reproducing device capable of reproducing an optical disc 1. The second reproducing device 300 includes an optical pickup 2, a motor 3, a demodulation circuit 4, a first OSD addition circuit 5, a third CPU 306, a second HDMI transmission circuit 307, a first output terminal 8, and a third remote controller 309.

The second display device 400 includes a first input terminal 201, a second EDID 402, a second HDMI reception circuit 403, a third OSD addition circuit 404, a fourth CPU 405, a displaying panel 206, a glasses control circuit 207, stereoscopic vision glasses 208, a second remote controller 209, a first audio amplifier 210, and a first speaker 211.

The second amplification device 600 includes a second input terminal 501, a fourth EDID 602, a fourth HDMI reception circuit 603, a fourth OSD addition circuit 504, a sixth CPU 605, a fourth HDMI transmission circuit 606, a second audio amplifier 507, a second output terminal 508, a fourth remote controller 509, an audio output terminal 510, and a second speaker 511.

In addition, the first output terminal 8 of the second reproducing device 300, and the second input terminal 501 of the second amplification circuit 600 are connected to each other through a second cable 20. The second output terminal 508 of the second amplification device 600, and the first input terminal 201 of the second display device 400 are connected to each other through a third cable 21.

When comparing the configuration in FIG. 15 to the configuration in FIG. 6, the second reproducing device 300 and the second display device 400 have the same configuration as those in the second reproducing device 300 and the second display device 400 according to the second embodiment.

When comparing the configuration in FIG. 15 to the configuration in FIG. 10, the second input terminal 501 of the second amplification device 600, the fourth OSD addition circuit 504, the second audio amplifier 507, the second output terminal 508, the fourth remote controller 509, the audio output terminal 510, and the second speaker 511 are common to those in the first amplification device 500 in the third embodiment. The third EDID 502 can be replaced with the fourth EDID 602. The third HDMI reception circuit 503 can be replaced with the fourth HDMI reception circuit 603. The fifth CPU 505 can be replaced with the sixth CPU 605. The third HDMI transmission circuit 506 can be replaced with the fourth HDMI transmission circuit 606.

Regarding the second amplification device 600, the fourth EDID 602 includes a memory element in which information relating to functions of the second amplification device 600 is stored, and stores the information in a form of a data array determined by the EDID in the EIA/CEA861-D standard. The memory element is a memory element capable of rewriting data. In addition, the fourth EDID 602 can store information relating to functions of the second display device 400 in a form of a data array determined by the EDID in the EIA/CEA861-D standard.

The fourth HDMI reception circuit 603 receives the HDMI signal through the second input terminal 501, and demodulates it into a stereoscopic image signal, a synchronization signal, an audio signal, and a packet signal.

The sixth CPU 605 is a microprocessor which controls the second amplification device 600. The sixth CPU 605 controls the fourth OSD addition circuit 504, and generates the OSD information according to an instruction from a user which is sent from the fourth remote controller 509.

The fourth HDMI transmission circuit 606 adds packet information which is sent from the sixth CPU 605 to the fourth OSD addition circuit 504 during an image blanking period such as a stereoscopic image output or the like, modulates the information to a digital image signal of the HDMI format, and outputs to the second display device 400 from the second output terminal 508.

4-2. Regarding Operation

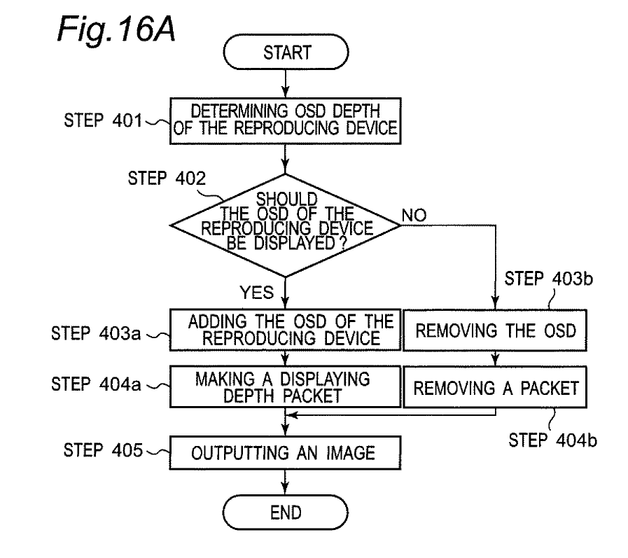

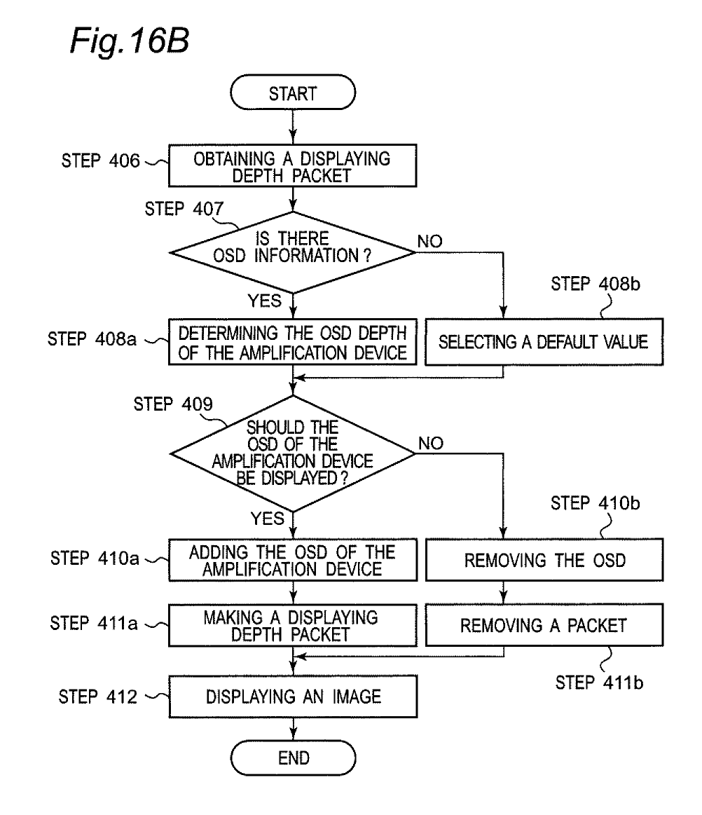

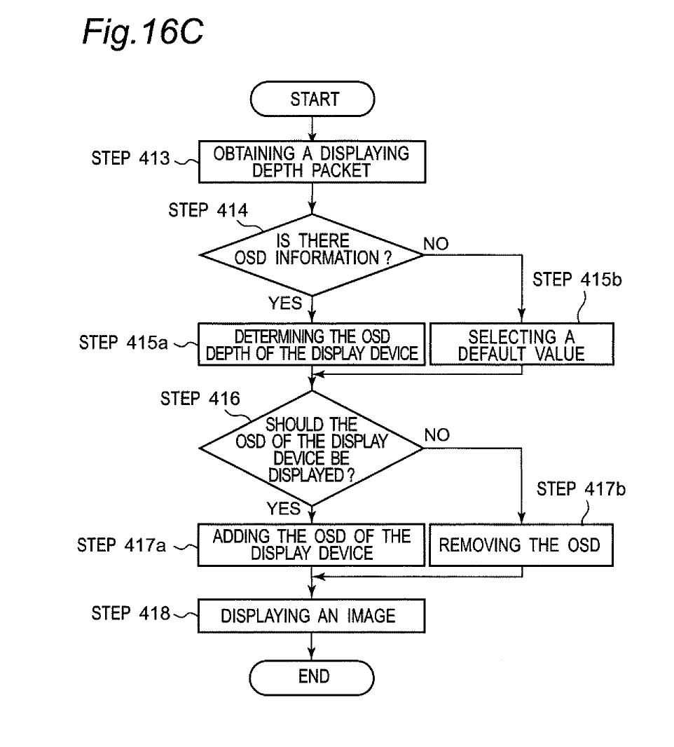

FIGS. 16A, 16B, and 16C are flowcharts which illustrate operation of the video system 2000 according to the fourth embodiment (second reproducing device 300, second amplification device 600, and second display device 400). Hereinafter, operation of the second reproducing device 300, the second amplification device 600, and the second display device 400 will be described with reference to the flowcharts.

4-2-a. Summary of Operation of Video System 2000

FIG. 16A is a flowchart relating to operation of the second reproducing device 300. With reference to FIG. 16A, first, in step 401, the second reproducing device 300 determines the OSD depth of the second reproducing device 300.

Subsequently, in step 402, the second reproducing device 300 determines whether or not to instruct an OSD display of the second reproducing device 300. When there is a display instruction, the second reproducing device 30C adds the OSD of the second reproducing device 300 to an image signal in step 403a. When there is no display instruction, the second reproducing device 300 removes (or does not add) the CSD (step 403b).

Further, in step 404a, the second reproducing device 300 makes OSD information of the second reproducing device 300 as a packet. When there is no display instruction (NO in step 402), the second reproducing device 300 removes the OSD, and removes the packet of the OSD information (step 404b).

Subsequently, in step 405, the second reproducing device 300C outputs an image signal to the second amplification device 600.

When continuously outputting images, step 402 to step 405 are repeated.

FIG. 16B is a flowchart relating to operation of the second amplification device 600. With reference to FIG. 16B, in step 406, the second amplification device 600 obtains a packet in which the OSD depth information of the second reproducing device 300 is included.

Subsequently, in step 407, the second amplification device 600 determines the presence or absence of OSD depth information of the second reproducing device 300. Here, when there is the OSD depth information of the second reproducing device 300, the second amplification device 600 adjusts the OSD depth information of the second amplification device 600 based on the OSD depth information of the second reproducing device 300 in step 408a. When there is no OSD depth information of the second reproducing device 300, the second amplification device 600 selects a preset default value as the OSD display depth of the second amplification device 600 (step 408b).

Subsequently, in step 409, the second amplification device 600 determines whether or not to instruct a display of the OSD of the second amplification device 600. When there is a display instruction, the second amplification device 600 adds the OSD of the second amplification device 600 to an image signal in step 410a. When there is no display instruction, the second amplification device 600 removes (or does not add) the OSD (step 410b).

Further, in step 411, the second amplification device 600 makes the OSD information of the second amplification device 600 as a packet. When there is no display instruction, the second amplification device 600 removes the OSD. Further, the second amplification device 600 removes the packet.

Subsequently, in step 412, the second amplification device 600 outputs an image signal to the second display device 400.

When continuously outputting images, step 409 to step 412 are repeated.

FIG. 16C is a flowchart relating to operation of the second display device 400. With reference to FIG. 16C, in step 413, the second display device 400 obtains a packet in which the OSD depth information of the second amplification device 600 is included.

Subsequently, in step 414, the second display device 400 determines the presence or absence of the OSD depth information of the second amplification device 600. Here, when there is the OSD depth information of the second amplification device 600, the second display device 400 adjusts the OSD display depth of the second display device 400 based on the OSD depth information of the second amplification device 600 in step 415a. When there is no CSD depth information of the second amplification device 600, the second display device 400 selects a preset default value as the OSD display depth of the second display device 400 (step 415b).

Subsequently, in step 416, the second display device 400 determines whether or not to instruct a display of the OSD of the second display device 400. When there is a display instruction, the second display device 400 adds the OSD of the second display device 400 to an image signal in step 417a. When there is no display instruction, the second display device 400 removes (or does not add) the CSD (step 417b).

Finally, in step 418, the second display device 400 displays an image on the displaying panel 206.

When continuously displaying images, step 416 to step 418 are repeated.

4-2-b. Detailed Operation of Video System 2000

(1) Determining of OSD Display Depth of Device Itself by Second Amplification Device 600

(1a) Reading of Second EDID 402 by Sixth CPU 605

The sixth CPU 605 of the second amplification device 600 performs reading of the second EDID 402 of the second display device 400 in the initial state. Information mainly relating to functions of the second display device 400 such as an image format which is prescribed in the EIA/CEA861-D standard is recorded in the non-volatile memory of the second EDID 402. The sixth CPU 605 reads the information through a serial transmission path which has passed through the third cable 21, and determined in the VESA/E-DDC standard.

(1b) Writing of Fourth EDID 602 of Second Amplification Device 600

Further, the sixth CPU 605 stores, in the fourth EDID 602, information relating to an image signal format which can be received by the second display device 400, and is read from the second EDID 402, and information relating to an audio signal format which can be received by the second amplification device 600.

(2) Operation of Second Reproducing Device 300

(2a) Reading of Fourth EDID 602 by Third CPU 306

The third CPU 306 of the second reproducing device 300 performs reading of the fourth EDID 602 of the second amplification device 600 in the initial state. An image format which can be received by the second display device 400, and an audio format which can be received by the second amplification device 600 are recorded in the non-volatile memory of the fourth EDID 602. The third CPU 306 reads the information through a serial transmission path which is determined in the VESA/E-DDC standard.

The second reproducing device 300 transmits a stereoscopic image signal in an image format which can be displayed by the second display device 400, and an audio signal in an audio format which can be amplified by the second amplification device 600 according to information of the fourth EDID 602.

(2b) Reproducing of Image Signal and Audio Signal

The optical disc 1 is recorded with a stereoscopic image signal, and an audio signal which are compressed by the MPEG 4 method. The optical pickup 2 converts the signals which are recorded in the optical disc 1 to electrical signals. The motor 3 rotates the optical disc 1 at a speed which is suitable for reproducing the optical disc 1.

The demodulation circuit 4 inputs an output of the optical pickup 2, performs an error correction or the like in the input, and demodulates it into the stereoscopic image signal and the audio signal. In the stereoscopic image, the right eye image and the left eye image respectively having 1080 pixels in the vertical direction and 1920 pixels in the horizontal direction are independently recorded at 24 frames/sec. Accordingly, the reproduced stereoscopic image also becomes an image signal in which the right eye image and the left eye image respectively have 1080 pixels in the vertical direction and 1920 pixels in the horizontal direction at 24 frames/sec.

(2c) Addition of OSD of Second Reproducing Device 300

The first OSD addition circuit 5 adds the OSD of the second reproducing device 300 to the respective right eye image and left eye image of the stereoscopic image signal reproduced in this manner as necessary. At this time, a user is able to change the OSD display depth using the third remote controller 309. That is, when a user delivers an instruction of changing the display depth using the third remote controller 309, the third CPU 306 determines the OSD display depth, for example, in a range of 128 to 192 according to the instruction. The first OSD addition circuit 5 adds the OSD to which an offset is added to the respective left eye image and right eye image according to the OSD depth information. A relationship between the OSD depth information and the offset amount in each of the left eye image and right eye image of the OSD is the same as that illustrated in Table 1 according to the first embodiment.

By changing the offset amount from 128 to 192, it is possible to change a protruding (depth) amount from the OSD screen of the second reproducing device 300. A user (viewer) is able to select an OSD display position which is easy to view for the user.

In addition, the third CPU 306 sends the OSD depth information which is determined in this manner to the second HDMI transmission circuit 307.

Hereinafter, in descriptions according to the present embodiment, it is assumed that a user sets the offset amount to “140”.

(3) Transmission of Image Signal and Audio Signal

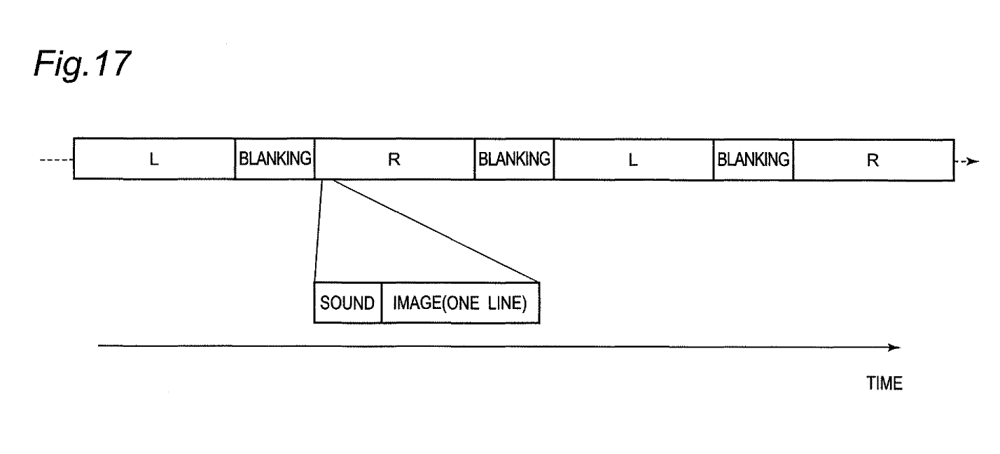

FIG. 17 is a diagram which illustrates a structure of an HDMI output signal of the second reproducing device 300 according to the fourth embodiment.

A stereoscopic image signal to which the OSD is added is sent to the second HDMI transmission circuit 307, and becomes a signal in which the left eye image and right eye image are multiplexed, respectively, in time division, as illustrated in FIG. 17. Each frame of the left eye image and the right eye image has a line structure, and a horizontal blanking period at the top of each line. The audio signal is multiplexed in each horizontal blanking period. In addition, the second HDMI transmission circuit 307 makes the OSD depth information which is sent from the third CPU 306 as a packet, and is multiplexed in the blanking between a frame of the left eye image and the right eye image of the stereoscopic image signal. The stereoscopic image signal becomes a signal in a form illustrated in FIG. 17, and is converted to a format suitable for transmission, and is output from the first output terminal 8.

(4) Operation of Second Amplification Device 600

(4a) Receiving Image Signal and Audio Signal of Second Amplification Device 600

The HDMI signal which is input from the second input terminal 501 is received by the fourth HDMI reception circuit 603, and is demodulated to the original stereoscopic image signal, an audio signal, and a packet signal. The stereoscopic image signal is sent to the fourth OSD addition circuit 504.

The audio signal is amplified in the second audio amplifier 507, and is output to the audio output terminal 510.

The second speaker 511 is connected to the audio output terminal 510, and a signal which is output from the audio output terminal 510 is delivered to a user by being converted to audio.

In addition, the OSD depth information which is made as a packet, and is multiplexed in a blanking among signals which are received by the fourth HDMI reception circuit 603, that is, the value “140” is sent to the sixth CPU 605.

(4b) Determining of OSD Display Depth of Second Amplification Device 600

The sixth CPU 605 illustrated in FIG. 15 determines the OSD display depth of the second amplification device 600 based on the OSD depth information which is sent from the fourth HDMI reception circuit 603, the value “140” according to the flowchart in FIG. 16B.

That is, the sixth CPU 605 determines the OSD display depth of the device itself so that the OSD of the second amplification device 600 is not located behind (so as to be located in front of) the OSD of the second reproducing device 300.

Since the OSD depth information of the second reproducing device 300 which is sent from the fourth HDMI reception circuit 603 is “140”, an OSD offset of the second reproducing device 300 becomes 140−128=+12. Accordingly, the OSD of the second reproducing device 300 is given with the offset of 12 pixels, and is displayed so as to be seen in front of the screen from a viewer.

Here, the sixth CPU 605 selects “150” which is larger than “140” as the OSD depth information of the second amplification device 600, for example. In this manner, the OSD offset of the second amplification device 600 becomes 150−128=+22. Accordingly, the OSD of the second amplification device 600 is given with the offset of 22 pixels, and is displayed so as to be seen in front of the screen from a viewer, and in front of the OSD of the second reproducing device 300.

(4c) Addition of OSD of Second Amplification Device 600

The OSD of the second amplification device 600 is added to the respective right eye image and left eye image of the received stereoscopic image signal as necessary. At this time, the OSD depth position of the right eye image and the left eye image is controlled according to the above-described OSD depth position. That is, as described above, since “150” is determined as the OSD depth information in the second amplification device 600, a protruding position (depth) of the OSD is determined by superimposing the right eye image on an image by offsetting the OSD by 22 pixels to the left, and the left eye image on the image by offsetting the OSD by 22 pixels to the right.

(5) Transmission of Image Signal

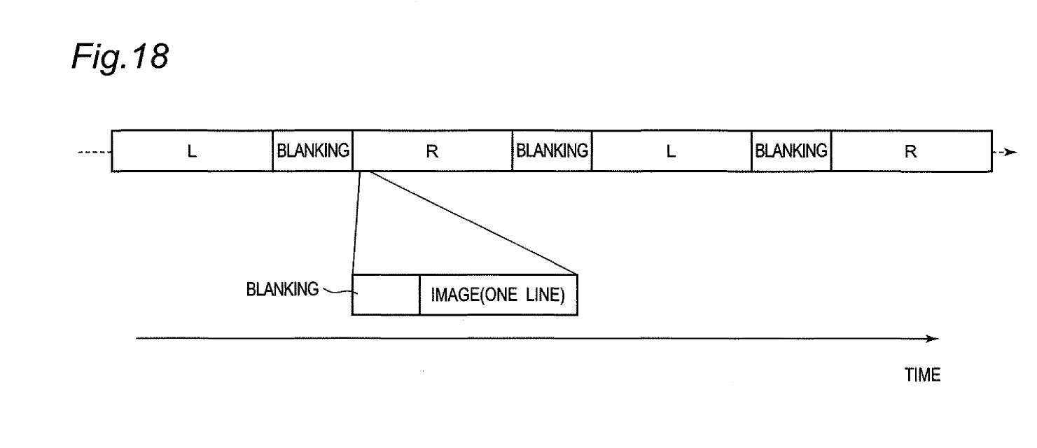

FIG. 18 is a diagram which illustrates a structure of outputting HDMI signal of the second amplification device 600 according to the fourth embodiment.

The stereoscopic image signal to which the OSD is added is sent to the fourth HDMI transmission circuit 606, and becomes a signal in which the left eye image and the right eye image are multiplexed in time division, respectively, as illustrated in FIG. 18. Each frame of the left eye image and right eye image has a line structure, and a horizontal blanking period at the top of each line. In addition, in the fourth HDMI transmission circuit 606, the OSD depth information which is sent from the sixth CPU 605, that is a value “150” is made as a packet, and is multiplexed in the blanking between a frame of the left eye image and the right eye image of the stereoscopic image signal. The stereoscopic image signal becomes a signal in a form illustrated in FIG. 18, and is converted to a format suitable for transmission, and is output from the second output terminal 508.

(6) Operation of Second Display Device 400

(6a) Reception of Image Signal by Second Display Device 400

The HDMI signal which is input from the first input terminal 201 is received by the second HDMI reception circuit 403, and is demodulated to the original stereoscopic image signal, and the packet signal. The stereoscopic image signal is sent to the third OSD addition circuit 404.

In addition, the OSD depth information which is made as a packet, and is multiplexed in a blanking among signals which are received by the second HDMI reception circuit 403, that is, the value “150” is sent to the fourth CPU 405.

(6b) Determining of OSD Display Position of Second Display Device 400

The fourth CPU 405 illustrated in FIG. 15 determines the OSD display depth of the second display device 400 based on the OSD depth information which is sent from the second HDMI reception circuit 403 according to the flowchart in FIG. 16C, that is, the value “150”.

That is, the fourth CPU 405 determines the OSD display depth of the device itself so that the OSD of the second display device 400 is not located behind (so as to be located in front of) the OSD of the second amplification device 600.

Since the OSD depth information of the second amplification device 600 which is sent from the second HDMI reception circuit 403 is “150”, an OSD offset of the second amplification device 600 becomes 150−128=+22. Accordingly, the OSD of the second amplification device 600 is given with the offset of 22 pixels, and is displayed so as to be seen in front of the screen, and in front of the OSD of the second reproducing device 300 from a viewer.

Here, the fourth CPU 405 selects “200” which is larger than “150” as the OSD depth information of the second display device 400, for example. In this manner, the CSD offset of the second display device 400 becomes 200−128=+72. Accordingly, the OSD of the second display device 400 is given with the offset of 72 pixels, and is displayed so as to be seen in front of the screen, and in front of the OSD of the second amplification device 600 from a viewer.

(6c) Addition of OSD by Second Display Device 400

The OSD of the second display device 400 is added to the respective right eye image and left eye image of the received stereoscopic image signal as necessary. At this time, the OSD display depth of the right eye image and the left eye image is controlled according to the above-described OSD depth position. That is, as described above, since “200” is determined as the OSD display information in the second display device 400, a protruding position (depth) of the OSD is determined by superimposing the right eye image on an image by offsetting the OSD by 72 pixels to the left, and the left eye image on the image by offsetting the OSD by 72 pixels to the right.

(6d) Driving of Displaying Panel 206 and Controlling of Stereoscopic Vision Glasses 208

In the second display device 400, the left eye image and the right eye image are sent in time division, and are sequentially displayed in the order of . . . left, right, left, right, . . . on the displaying panel 206. The stereoscopic vision glasses 208 are provided with the liquid crystal shutters which are separated on the left and right, and are able to control transmission and non-transmission of light. The stereoscopic vision glasses 208 controls the stereoscopic vision glasses 208 so as to close the right shutter while the displaying panel 206 is outputting the left eye image, and close the left shutter while the displaying panel 206 is outputting the right eye image according to an infrared signal from the glasses control circuit 207. In this manner, only the right eye image is guided to the right eye of a viewer (user), and only the left eye image is guided to the left eye thereof. Accordingly, the viewer is able to view a stereoscopic image.

4-3. Conclusion

The second amplification device 600 according to the fourth embodiment is an amplification device capable of receiving a first stereoscopic image signal including a stereoscopic image which can be viewed stereoscopically from a second reproducing device 300 and superimposing an amplification device image (OSD) being an image different from the stereoscopic image onto the stereoscopic image to generate and transmit a second stereoscopic image signal to a second display device 400.

The second amplification device 600 includes: a reception unit (fourth HDMI reception circuit 603) operable to receive the first stereoscopic image signal; an acquisition unit (sixth CPU 605) operable to obtain information about reproducing device image depth, the reproducing device image depth being stereoscopic vision depth that the second reproducing device 300 capable of superimposing a reproducing device image (OSD) being an image different from the stereoscopic image onto the stereoscopic image gives to the reproducing device image when the reproducing device superimposes the reproducing device image onto the stereoscopic image; a superimposing unit (fourth OSD addition circuit 504) operable to give amplification device image depth to the amplification device image based on the information about reproducing device image depth obtained by the acquisition unit and superimpose the amplification device image onto the stereoscopic image to generate the second stereoscopic image signal; and a transmission unit (fourth HDMI transmission circuit 606) operable to transmit the second stereoscopic image signal to the second display device 400.

The video system 2000 according to the fourth embodiment is a video system including a second reproducing device 300, a second display device 400, and a second amplification device 600.

The second reproducing device 300 is a reproducing device capable of superimposing a reproducing device image (OSD) being an image different from a stereoscopic image onto the stereoscopic image which can be viewed stereoscopically to generate and output a first stereoscopic image signal. The second reproducing device 300 includes: a superimposing unit (first OSD addition circuit 5) operable to give reproducing device image depth of a predetermined stereoscopic vision depth to the reproducing device image and superimpose the reproducing device image onto the stereoscopic image to generate the first stereoscopic image signal; and a transmission unit operable to transmit the first stereoscopic image signal to the second amplification device 600.

The second amplification device 600 is an amplification device capable of receiving the first stereoscopic image signal from the second reproducing device 300 and superimposing an amplification device image (OSD) being an image different from the stereoscopic image onto the stereoscopic image to generate and transmit a second stereoscopic image signal to a second display device 400. The second amplification device 600 includes: a reception unit (fourth HDMI reception circuit 603) operable to receive the first stereoscopic image signal; an acquisition unit (sixth CPU 605) operable to obtain information about reproducing device image depth; a superimposing unit (fourth OSD addition circuit 504) operable to give amplification device image depth to the amplification device image based on the information about reproducing device image depth obtained by the acquisition unit and superimpose the amplification device image onto the stereoscopic image to generate the second stereoscopic image signal; and a transmission unit (fourth HDMI transmission circuit 606) operable to transmit the second stereoscopic image signal to the second display device 400.

The second display device 400 is a display device capable of receiving the second stereoscopic image signal from the second amplification device 600 and superimposing a display device image (OSD) being an image different from the stereoscopic image onto the stereoscopic image to display the stereoscopic image. The second display device 400 includes: a reception unit (second HDMI reception circuit 403) operable to receive the second stereoscopic image signal; an acquisition unit (fourth CPU 405) operable to obtain information about amplification device image depth; a superimposing unit (third OSD addition circuit 404) operable to give display device image depth to the display device image based on the information about amplification device image depth obtained by the acquisition unit and superimpose the display device image onto the stereoscopic image to generate a third stereoscopic image signal; and a display unit (displaying panel 206) operable to display an image based on the third stereoscopic image signal.

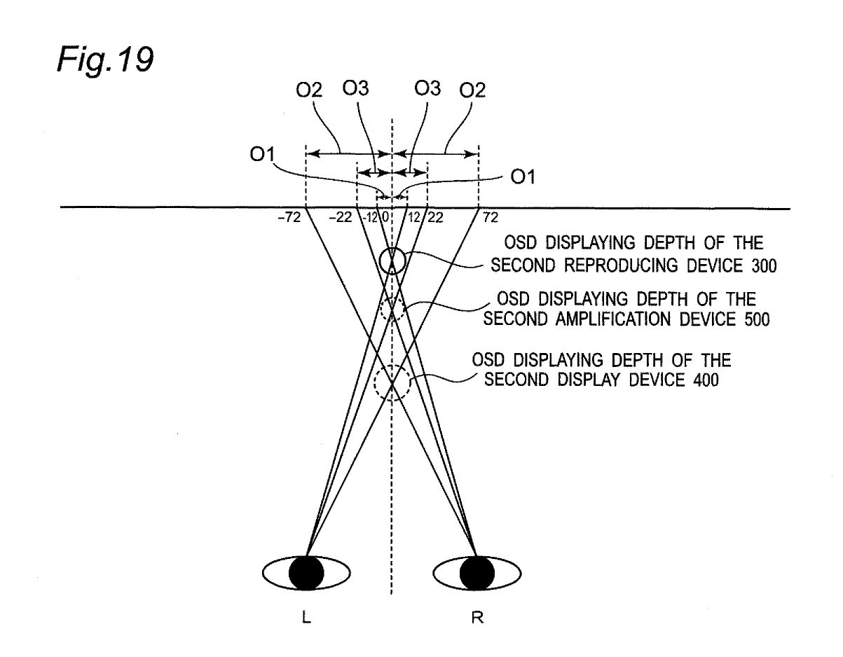

FIG. 19 is a diagram which illustrates each display depth of the plurality of OSDs according to the present embodiment.

As illustrated in FIG. 19, according to the present embodiment, the second amplification device 600 controls the OSD display depth of the second amplification device 600 based on the OSD depth information of the second reproducing device 300. In addition, the second display device 400 controls the OSD display depth of the second display device 400 based on the OSD depth information of the second amplification device 600. In this manner, as illustrated in FIG. 19, the OSD of the second amplification device 600 is displayed so as to be seen in front of the OSD of the second reproducing device 300 from a viewer. In addition, the OSD of the second display device 400 is displayed so as to be seen in front of the OSD of the second amplification device 600 from a viewer. As a result, it is possible to eliminate the malfunction in which the OSD which is overwritten on the image later, and is added thereto is displayed with the sense of depth deeper than the OSD which is overwritten on the image earlier, and is added thereto.

### 5. Fifth Embodiment

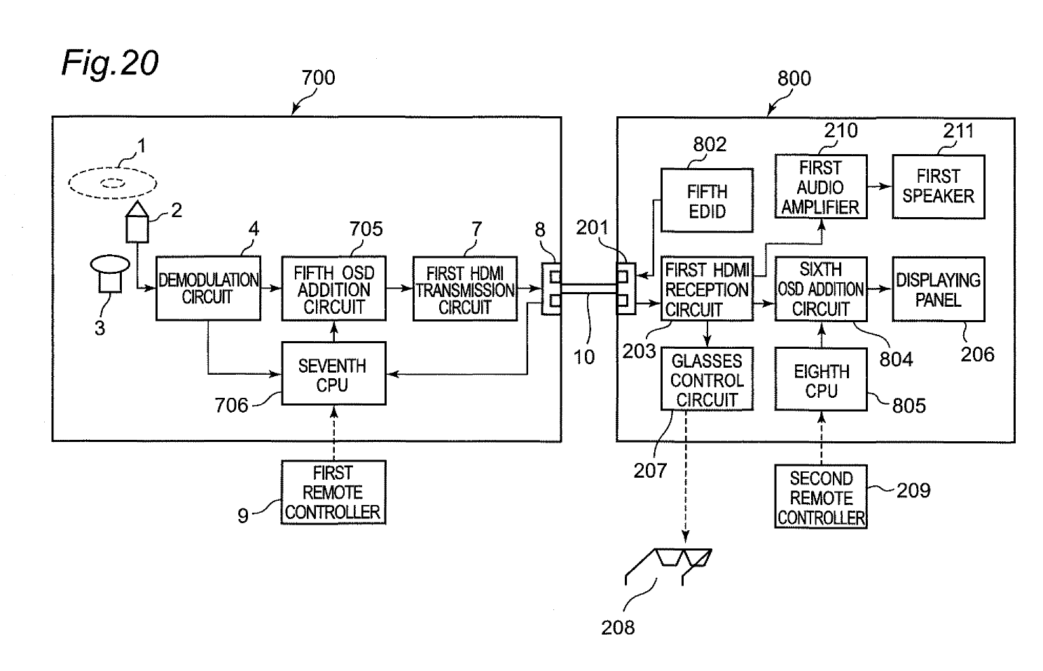

Hereinafter, a reproducing device and a display device according to a fifth embodiment will be described. The reproducing device and display device according to the present embodiment can be industrially manufactured based on the internal configuration diagram illustrated in FIG. 20.

5-1. Regarding Configuration

FIG. 20 is a block diagram which illustrates an internal configuration of a third reproducing device 700, and a third display device 800 according to a fifth embodiment. In this figure, the third reproducing device 700 is an image reproducing device capable of reproducing an optical disc 1. The third reproducing device 700 includes an optical pickup 2, a motor 3, a demodulation circuit 4, a fifth OSD addition circuit 705, a seventh CPU 706, a first HDMI transmission circuit 7, a first output terminal 8, and a first remote controller 9.

The third display device 800 includes a first input terminal 201, a fifth EDID 802, a first HDMI reception circuit 203, a sixth OSD addition circuit 804, an eighth CPU 805, a displaying panel 206, a glasses control circuit 207, stereoscopic vision glasses 208, a second remote controller 209, a first audio amplifier 210, and a first speaker 211.

In addition, the first output terminal 8 of the third reproducing device 700, and the first input terminal 201 of the third display device 800 are connected to each other through a first cable 10.

When comparing a configuration illustrated in FIG. 20 to the configuration in FIG. 1, the optical pickup 2, the motor 3, the demodulation circuit 4, the first HDMI transmission circuit 7, the first output terminal 8, and the first remote controller 9 in the third reproducing device 700 are common to those in the first reproducing device 100 according to the first embodiment. The first CPU 6 is replaced with the seventh CPU 706. The first OSD addition circuit 5 is replaced with the fifth OSD addition circuit 705.

In addition, the first input terminal 201, the first HDMI reception circuit 203, the displaying panel 206, the glasses control circuit 207, the stereoscopic vision glasses 208, the second remote controller 209, the first audio amplifier 210, and the first speaker 211 in the third display device 800 are common to those in the first display device 200 according to the first embodiment. The first EDID 202 is replaced with the fifth EDID 802. The second OSD addition circuit 204 is replaced with the sixth OSD addition circuit 804. The second CPU 205 is replaced with the eighth CPU 805.

The fifth OSD addition circuit 705 overwrites (superimposes) a stereoscopic image (hereinafter, abbreviated as “stereoscopic OSD”) of information (stereoscopic OSD) which is configured by stereoscopic characters (characters to be stereoscopically viewed), or a stereoscopic icon (icon to be stereoscopically viewed) on respective image signals of the left eye image and the right eye image which are included in the stereoscopic image signal which is output from the demodulation circuit 4, and outputs the signals.

The seventh CPU 706 is a microprocessor which controls the third reproducing device 700. The seventh CPU 706 controls the fifth OSD addition circuit 705, and generates stereoscopic OSD information based on operation of a user which is sent from the first remote controller 9, or reproducing information which is obtained by the demodulation circuit 4 as necessary.

Regarding the third display device 800, the fifth EDID 802 includes a memory element in which information relating to functions which are included in the third display device 800 is stored, and stores the information in a form of a data array determined in the EDID standard of the EIA/CEA 861-D. According to the present embodiment, the fifth EDID 802 is added with information indicating the maximum depth of stereoscopic OSD of the third display device 800 to be described later therein, that is, the stereoscopic OSD maximum depth information. In addition, the fifth EDID 802 may store information in a range of the depth of the stereoscopic OSD, that is, the stereoscopic OSD depth information including the stereoscopic OSD maximum depth information or the stereoscopic OSD minimum depth information.

The sixth OSD addition circuit 804 overwrites (superimposes) an image (stereoscopic OSD) of information of stereoscopic characters or a stereoscopic icon on respective image signals of the left eye image and the right eye image of the stereoscopic image signal which is output from the first HDMI reception circuit 203, and outputs the signals.

The eighth CPU 805 is a microprocessor which controls the third display device 800. The eighth CPU 805 controls the sixth OSD addition circuit 804, and generates stereoscopic OSD information including the stereoscopic OSD maximum depth information according to an instruction from a user which is sent from the second remote controller 209.

5-2. Regarding Operation

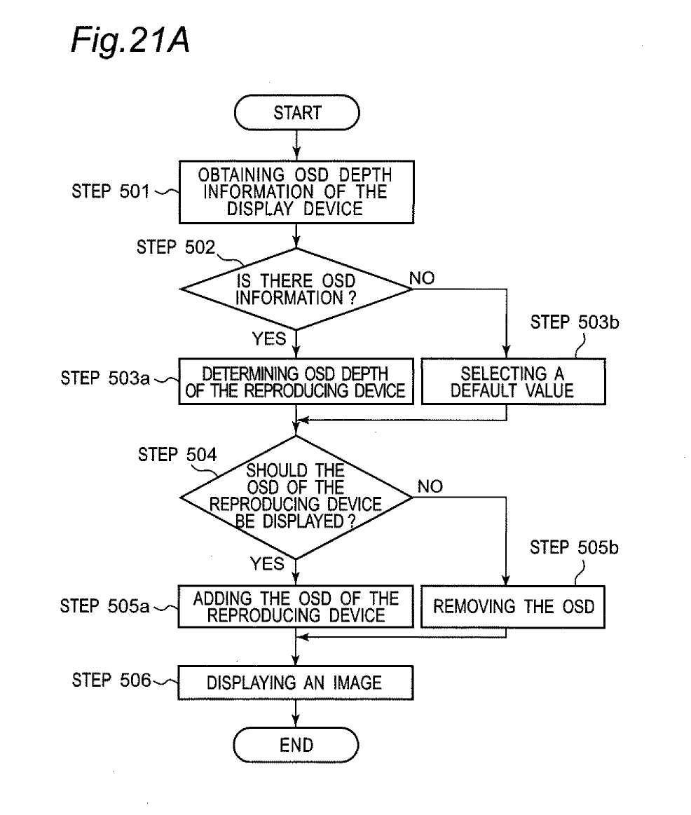

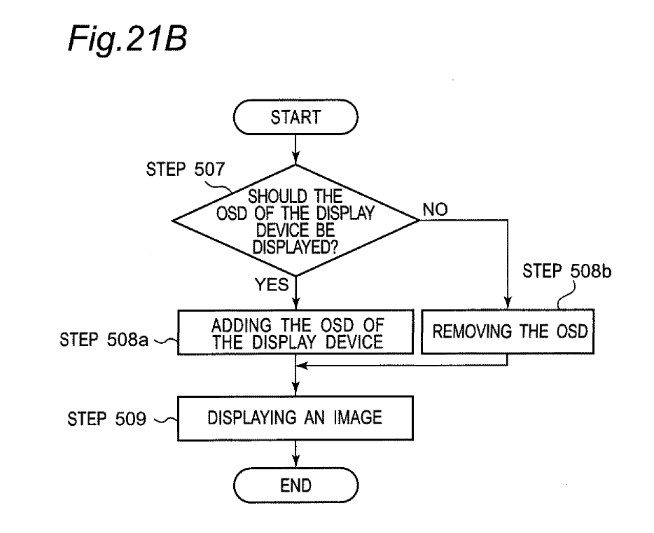

FIGS. 21A and 213 are flowcharts which illustrate operation of the third reproducing device 700 and the third display device 800 according to the fifth embodiment. Hereinafter, the operation of the third reproducing device 700 and the third display device 800 will be described with reference to the flowcharts.

5-2-a. Summary of Operation of Third Reproducing Device 700 and Third Display Device 800

FIG. 21A is a flowchart relating to operation of the third reproducing device 700. With reference to FIG. 21A, first, in step 501, the third reproducing device 700 obtains stereoscopic OSD maximum depth information which is included in stereoscopic OSD depth information of the third display device 800.

Subsequently, in step 502, the third reproducing device 700 determines the presence or absence of the stereoscopic OSD maximum depth information of the third display device 800. Here, when there is the stereoscopic OSD maximum depth information of the third display device 800, the stereoscopic OSD display depth of the third reproducing device 700 is adjusted based on the stereoscopic OSD maximum depth information of the third display device 800 in step 503a. When there is no stereoscopic OSD maximum depth information of the third display device 800 in step 503b, the third reproducing device 700 selects a preset default value as the stereoscopic OSD display depth of the third reproducing device 700 (step 503b).

Subsequently, in step 504, the third reproducing device 700 determines whether or not to instruct a display of the stereoscopic OSD of the third reproducing device 700. Here, when there is a display instruction, the third reproducing device 700 adds the stereoscopic OSD of the third reproducing device 700 to an image signal in step 505a. When there is no display instruction, the third reproducing device 700 removes (or does not add) the stereoscopic OSD (step 505b).

Subsequently, in step 506, the third reproducing device 70C outputs an image signal to the third display device 800.

When continuously outputting images, step 504 to step 506 are repeated.

FIG. 21B is a flowchart relating to operation of the third display device 800. With reference to FIG. 21B, in step 507, the third display device 800 determines whether or not to instruct a display of the stereoscopic OSD of the third display device 800. Here, when there is a display instruction, the third display device 800 adds the stereoscopic OSD of the third display device 800 to an image signal in step 508a. When there is no display instruction, the third display device 800 removes (or does not add) the stereoscopic OSD (step 508b).

Finally, in step 509, the third display device 800 displays an image on the displaying panel 206.

When continuously displaying images, step 507 to 509 are repeated.

5-2-b. Detailed Descriptions of Operation of Third Reproducing Device 700 and Third Display Device 800

(1) Operation of Third Reproducing Device 700

(1a) Reading of Fifth EDID 802 by Seventh CPU 706

The seventh CPU 706 of the third reproducing device 700 performs reading of the fifth EDID 802 of the third display device 800 in the initial state or in step 501. In a non-volatile memory of the fifth EDID 802, stereoscopic OSD maximum depth information to be described later is recorded along with information mainly relating to functions included in the third display device 800 such as an image format which is prescribed in the EIA/CEA 861-D standard. The seventh CPU 706 reads the information through the serial transmission path which has passed through the first cable 10, and determined in the VESA/E-DDC standard.

The third reproducing device 700 transmits the image signal and the audio signal in a form of an image format which can be displayed by the third display device 800 according to information of the fifth EDID 802.

(1b) Controlling of OSD Display Depth

A relationship between the stereoscopic OSD depth information and the offset amount in each of the left eye image and the right eye image of the stereoscopic OSD can be easily understood based on descriptions with reference to Table 1 or the like according to the first embodiment. For this reason, descriptions of the relationship between the stereoscopic OSD depth information and the offset amount will be omitted.

The OSD according to the fifth embodiment is configured by a stereoscopic OSD including a three-dimensional (stereoscopic) object, that is, an object to be stereoscopically viewed. In the stereoscopic OSD, the respective stereoscopic OSD for left eye image and the stereoscopic OSD of right eye image are configured as graphic bitmaps. In addition, the depth (front-back position of stereoscopic image) in which the stereoscopic OSD is displayed is variable along with a range of the depth.

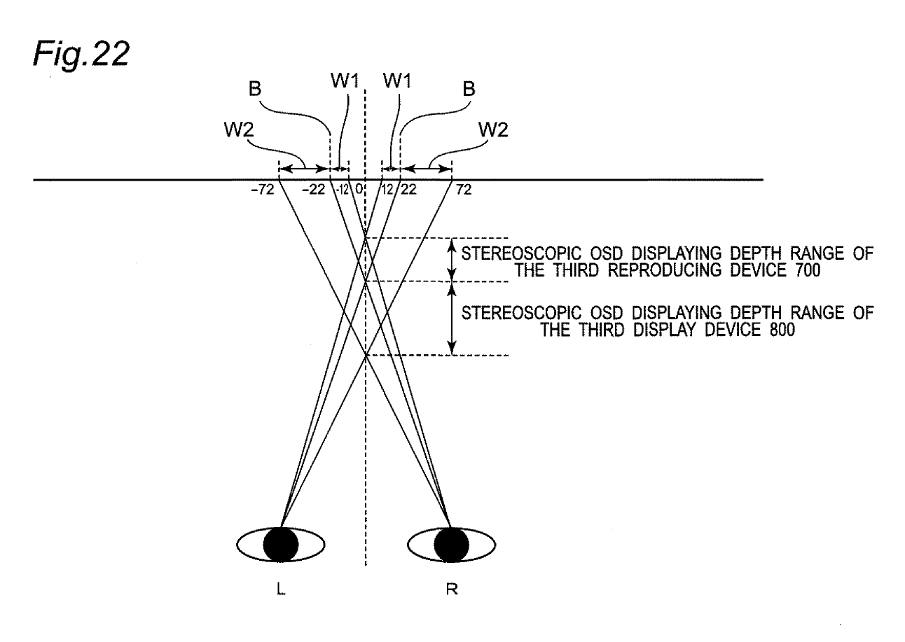

FIG. 22 is a diagram which describes a principle of the depth (sense of depth) in the stereoscopic OSD. The depth when displaying information of the stereoscopic characters, the stereoscopic icon, or the like, which is displayed as the stereoscopic OSD is determined in the third reproducing device 700 and the third display device 800. A position in the three dimensional depth direction (depth direction in stereoscopic vision) is reflected in an offset value at the time of superimposing the stereoscopic OSD on the respective left eye image and right eye image. That is, in FIG. 22, the stereoscopic OSD of the third reproducing device 700 has an offset range W1 of 10 pixels in each of the left eye image and the right eye image. The stereoscopic OSD of the third display device 800 has an offset range W2 of 50 pixels in each of the left eye image and right eye image. The offset amount of the stereoscopic OSD which is displayed so as to be seen at the maximum depth of the third display device 800, that is, the farthest position in the stereoscopic OSD of the third display device 800 from a viewer is 22. In this case, according to the relationship between the depth information and the offset illustrated in Table 1, the stereoscopic OSD maximum depth information of the third display device 800 becomes 128+22=150. In the third display device 800 according to the present embodiment, the stereoscopic OSD maximum depth information which is determined as above, that is, the value 150 is recorded at a predetermined position of the fifth EDID 802.

(1c) Determining Stereoscopic OSD Display Depth of Third Reproducing Device 700

The seventh CPU 706 of the third reproducing device 700 illustrated in FIG. 20 reads the stereoscopic OSD maximum depth information of the third display device 800 which is recorded in the fifth EDID 802 according to the flowchart illustrated in FIG. 21A, and determines the stereoscopic OSD display depth of the third reproducing device 700 based on the value (stereoscopic OSD maximum depth information of third display device 800).

That is, the seventh CPU 706 determines the stereoscopic OSD depth position of the device itself so that the stereoscopic OSD of the third reproducing device 700 is not located in front of (so as to be located behind) the stereoscopic OSD of the third display device 800.

For example, when the value which is stored in the fifth EDID 802 of the third display device 800 (stereoscopic OSD maximum depth information) is “150”, an offset of an object which is located farthest among the stereoscopic OSDs of the third display device 800 becomes 150−128=−22. Accordingly, in the stereoscopic OSDs of the third display device 800, the object which is located the farthest is given the offset of 22 pixels, and is displayed so as to be seen in front of the screen from a viewer.

Here, the seventh CPU 706 of the third reproducing device 700 sets the stereoscopic OSD of the device itself so that the foremost depth (minimum depth) in the display depth of the OSD display of the third reproducing device 700 matches the farthest depth (maximum depth) among the stereoscopic OSDs which are displayed by the third display device 800, or is located further behind. In this manner, it is set such that the sense of depth of the stereoscopic OSD of the third reproducing device 700 and the sense of depth of the stereoscopic OSD of the third display device 800 is not overlapped with each other. For example, the value which is stored in the fifth EDID 802 as the stereoscopic OSD maximum depth information of the third display device 800 is set to “150”. In addition, as illustrated in FIG. 22, it is assumed that the stereoscopic OSD of the third reproducing device 700 has the width of an offset amount of 10 pixels (offset range W1). In this case, the third reproducing device 700 selects, for example, 140 (150−10=140) as the stereoscopic OSD maximum depth information relating to the stereoscopic OSD of the device itself. In this manner, the offset range W1 relating to the stereoscopic OSD of the third reproducing device 700 becomes 12 (140−128=12) to 22 (12+10=22). On the other hand, the stereoscopic OSD of the third display device 800 is displayed by being given an offset of an offset value “+22” or more. Accordingly, the stereoscopic OSD of the third reproducing device 700 is displayed so as to be seen behind the stereoscopic OSD of the third display device 800 from a viewer.

(1d) Reproducing Image Signal and Audio Signal

The optical disc 1 is recorded with a stereoscopic image signal and an audio signal which are compressed by the MPEG 4 method. The optical pickup 2 converts signals recorded in the optical disc 1 to electrical signals. The motor 3 rotates the optical disc 1 at a speed suitable for reproducing.

The demodulation circuit 4 inputs an output of the optical pickup 2, performs an error correction or the like in the input, and demodulates it into the stereoscopic image signal and the audio signal. In the stereoscopic image, the right eye image and the left eye image respectively having 1080 pixels in the vertical direction and 1920 pixels in the horizontal direction are independently recorded at 24 frames/sec. Accordingly, the reproduced stereoscopic image also becomes an image signal in which the right eye image and the left eye image respectively have 1080 pixels in the vertical direction and 1920 pixels in the horizontal direction at 24 frames/sec.

(1e) Addition of Stereoscopic OSD of Third Reproducing Device 700

The fifth OSD addition circuit 705 adds the stereoscopic OSD of the third reproducing device 700 to the respective right eye image and left eye image of the stereoscopic image signal which is reproduced in this manner as necessary. At this time, the stereoscopic OSD display positions of the respective right eye image and left eye image are controlled according to the above-described stereoscopic OSD depth information. That is, as described above, “140” is selected in advance as the stereoscopic OSD (maximum) depth information of the third reproducing device 700, and as described above, the width of the stereoscopic OSD offset of the third reproducing device 700 is 10. Accordingly, the stereoscopic OSD of the third reproducing device 700 is displayed with an offset in which the stereoscopic OSD information is between 10 pixels and 22 pixels to the left in the right eye image, and an offset in which the stereoscopic OSD information is between 10 pixels and 22 pixels to the right in the left eye image.

(2) Transmission of Image Signal and Audio Signal

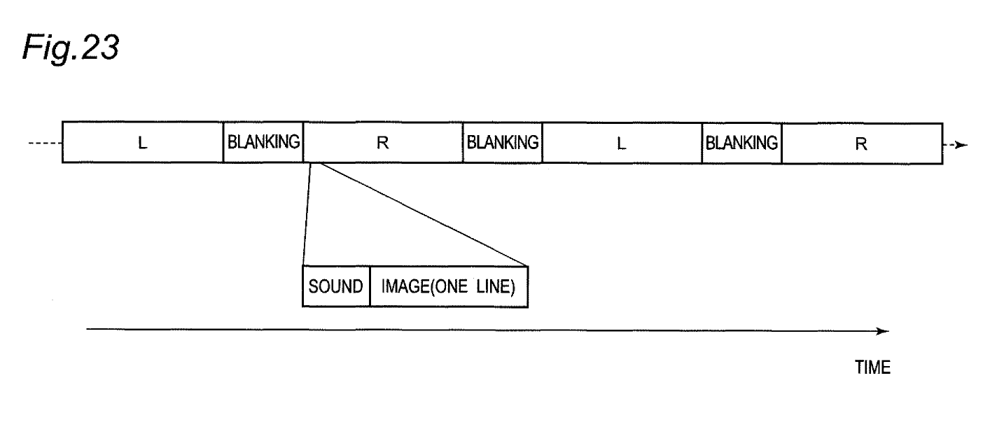

FIG. 23 is a diagram which illustrates a structure of the HDMI signal according to the present embodiment.

The stereoscopic image signal to which the stereoscopic OSD is added is transmitted to the first HDMI transmission circuit 7, and becomes a signal in which the left eye image and the right eye image are multiplexed in time division, respectively, as illustrated in FIG. 23. Each frame of the left eye image and the right eye image has a line structure, and a horizontal blanking period at the top of each line. An audio signal is multiplexed in each of the horizontal blanking periods.

In this manner, the signal in which the stereoscopic image and the audio signal are multiplexed is converted to a format suitable for transmission, and is output from the first output terminal 8.

(3) Operation of Third Display Device 800

(3a) Reception of Image Signal and Audio Signal by Third Display Device 800

The HDMI signal which is input from the first input terminal 201 is received by the first HDMI reception circuit 203, and is demodulated to the original stereoscopic image signal and the audio signal. The stereoscopic image signal is transmitted to the sixth OSD addition circuit 804.

The audio signal is amplified in the first audio amplifier 210, and is delivered to a user through the first speaker 211.

(3b) Addition of Stereoscopic OSD of Third Display Device 800

The stereoscopic OSD of the third display device 800 is added to the respective right eye image and left eye image of the received stereoscopic image signal as necessary. At this time, the stereoscopic OSD display depths of the right eye image and the left eye image are controlled according to the above-described stereoscopic OSD depth information. That is, as described above, “150” is preset as the stereoscopic OSD (maximum) depth information in the third display device 800, and as described above, the stereoscopic OSD offset of the third display device 800 (offset width, offset range) is 50. Accordingly, in the stereoscopic OSD of the third display device 800, a protruding position of the stereoscopic OSD (depth) is determined by superimposing on the image by adding an offset of 22 pixels to 72 pixels to the left for the right eye image, and by adding an offset of 22 pixels to 72 pixels to the right for the left eye image.

(3c) Driving of Displaying Panel 206 and Controlling of Stereoscopic Vision Glasses 208

In the third display device 800, the left eye image and the right eye image are sent in time division, and are sequentially displayed in the order of . . . left, right, left, right, . . . on the displaying panel 206. The stereoscopic vision glasses 208 are provided with the liquid crystal shutters which are separated on the left and right, and are able to control transmission and non-transmission of light. The stereoscopic vision glasses 208 are controlled so as to close the right shutter while the displaying panel 206 is outputting the left eye image, and close the left shutter while the displaying panel 206 is outputting the right eye image according to an infrared signal from the glasses control circuit 207. In this manner, only the right eye image is guided to the right eye of a viewer (user), and only the left eye image is guided to the left eye thereof. Accordingly, the viewer is able to view a stereoscopic image.

5-3. Conclusion

The third reproducing device 700 can control the OSD display depth of the third reproducing device 700 based on the stereoscopic OSD display depth of the third display device 800. In addition, the third reproducing device 700 can generate a stereoscopic OSD including a portion which is seen with a different sense of depth from a viewer.

Accordingly, as illustrated in FIG. 21, the stereoscopic OSD of the third reproducing device 700 is displayed so as to be seen with the same maximum depth as or behind the OSD of the third display device 800 from a viewer. Accordingly, it is possible to eliminate the malfunction in which the stereoscopic CSD which is added later is displayed behind the stereoscopic OSD which is added previously.

### 6. Other Embodiments

The plurality of embodiments have been exemplified, as described above. However, the embodiments are not limited thereto. Hereinafter, examples of other embodiments will be described. Note that the embodiments are not limited thereto.

According to the first embodiment, the embodiment has been exemplified in which the first reproducing device 100 includes the first CPU 6 as a determination unit which determines the OSD display depth and generates the OSD, the first OSD addition circuit 5 as the superimposing unit which superimposes the OSD generated by the first CPU 6 on the image signal and outputs the signal, and the first HDMI transmission circuit 7 as an image transmission unit which transmits the image signal which is output from the first OSD addition circuit 5 to the first display device 200.

However, the present embodiment is not limited thereto. For example, the first reproducing device 100 may be separately provided with a notification unit which notifies the first display device 200 of information relating to the depth of the OSD. In addition, an image transmission unit (first HDMI transmission circuit 7) of the first reproducing device 100 may include the function of the above-described notification unit.

According to such a configuration, the first display device 200 is able to obtain information relating to the OSD depth of the first reproducing device 100, regardless of whether receiving the image signal or not.

According to the first embodiment, the embodiment has been exemplified in which the OSD generated in the first reproducing device 100 is displayed so as to be seen behind the OSD generated in the first display device 200.

However, the present embodiment is not limited thereto. For example, the OSD generated in the first reproducing device 100 may be displayed on the same plane as the OSD generated in the first display device 200 from a viewer.

Even with such a configuration, since the OSD which is added later is not seen behind the OSD which is added earlier, from a viewer, it is possible to realize an OSD display with high visibility for the viewer.

According to the second embodiment, the embodiment has been exemplified in which the second display device 400 includes the fourth CPU as a determination unit which adjusts the CSD display depth as the OSD depth generated in the second display device 400, determines the OSD display depth, and generates the OSD based on the OSD depth information including information relating to the depth of the OSD which is superimposed on the image signal transmitted from the second reproducing device 300.

However, the present embodiment is not limited thereto. For example, a notification unit (depth information transmission unit) which notifies the second reproducing device 300 of information relating to the OSD depth may be separately provided in the second display device 400.

According to such a configuration, the second reproducing device 300 can obtain information relating to the OSD depth of the second display device 400 in advance.

According to the second embodiment, the embodiment has been exemplified in which the OSD generated in the second display device 400 is displayed in front of the OSD generated in the second reproducing device 300 from a viewer.

However, the present embodiment is not limited thereto. For example, the OSD generated in the second display device 400 may be displayed so as to be seen on the same plane as the OSD generated in the second reproducing device 300 from a viewer.

Even with such a configuration, since the OSD which is added later is not seen behind the OSD which is added earlier, from a viewer, it is possible to realize the OSD display with high visibility.

According to the third embodiment, the embodiment has been exemplified in which the OSD of the first reproducing device 100 is displayed so as to be seen behind the OSD of the first amplification device 500, and the OSD of the first display device 200 is displayed so as to be seen in front of the OSD of the first amplification device 500 from a viewer.

However, the present embodiment is not limited thereto. For example, the fifth CPU 505 as the determination unit of the first amplification device 500 may adjust the OSD depth of the first amplification device 500 so that the OSD of the first display device 200 and the OSD of the first amplification device 500 are seen on the same plane from a viewer. In addition, the firs: CPU 6 as the determination unit of the first reproducing device 100 may adjust the generated OSD depth so that the OSD of the first reproducing device 100 and the OSD of the first amplification device 500 are seen on the same plane from a viewer.

Even with such a configuration, since the OSD which is added later is not seen behind the OSD which is added earlier, from a viewer, it is possible to realize the OSD display with high visibility for a viewer.

In addition, a notification unit which notifies at least any of the first reproducing device 100 and the first display device 200 of information relating to the OSD depth may be additionally provided in the first amplification device 500.

According to the fourth embodiment, the embodiment has been exemplified in which the OSD of the second amplification device 600 is displayed so as to be seen in front of the OSD of the second reproducing device 300 from a viewer, and the OSD of the second display device 400 is displayed so as to be seen in front of the OSD of the second amplification device 600 from a viewer.

However, the present embodiment is not limited thereto. For example, the sixth CPU 605 as a determination unit of the second amplification device 600 may adjust the OSD depth of the second amplification device 600 so that the OSD of the second amplification device 600 and the OSD of the second reproducing device 300 are seen on the same plane from a viewer. In addition, the fourth CPU 405 as a determination unit of the second display device 400 may adjust the OSD depth of the second display device 400 so that the OSD of the second display device 400 and the OSD of the second amplification device 600 are seen on the same plane from a viewer.

Even with such a configuration, since the OSD which is added later is not seen behind the OSD which is added earlier, from a viewer, it is possible to realize the OSD display with high visibility for a viewer.

In addition, a notification unit which notifies at least any of the second reproducing device 300 and the second display device 400 of information relating to the OSD depth may be additionally provided in the second amplification device 600.

According to the fifth embodiment, the embodiment has been exemplified in which the third reproducing device 700 controls the stereoscopic OSD display depth of the third reproducing device 700 according to the stereoscopic OSD (maximum) depth information of the third display device 800.

However, the present embodiment is not limited thereto. For example, only any one of the OSD of the third reproducing device 700, and the OSD of the third display device 800 may be the stereoscopic OSD. Further, any one of the OSDs described in the first to fourth embodiment may be the stereoscopic OSD.

In the first to fifth embodiment, the device that reproduces the optical disc 1 has been exemplified as the reproducing device, however, the embodiment is not limited thereto. The configuration of the reproducing device according to the embodiment can be applied to a reproducing device which reproduces an image which is stored in a flash memory, a reproducing device which reproduces an image which is stored in a hard disk drive, or the like, as well. In short, it is possible to apply the configuration of the reproducing device according to the embodiment to any reproducing device having a function of displaying the OSD, and to a video system which includes any reproducing device having the function of displaying the OSD.

In the first to fifth embodiments, the device which includes the displaying panel 206 having 1080 pixels in the vertical direction and 1920 pixels in the horizontal direction has been exemplified as the display device, however, the embodiment is not limited thereto. For example, it is also possible to apply the configuration of the display device according to the embodiment to a display device which includes a displaying panel having 2160 pixels in the vertical direction and 3840 pixels in the horizontal direction. There is no limitation for resolution of the display device of the embodiment. In short, it is possible to apply the configuration of the display device according to the embodiment to any display device having the function of displaying the OSD, and to the video system which includes any display device having the function of displaying the OSD.

According to the first to fifth embodiments, the embodiment has been exemplified in which the OSD depth information is snored as 8 bits data, and is suitably read, however, the embodiment is not limited thereto. In the embodiment, the OSD depth information may be suitably set in an arbitrary bounded range. In short, according to the embodiment, the OSD depth information is only required to be set in the reproducing device and the display device, respectively. The configuration of the embodiment can be applied as long as it is a video system in which the OSD depth information is set in the reproducing device, the display device, and the amplification device, respectively.

In addition, it is possible to further add improvement or modification regarding a technical topic such as a connection to stream information, making constituent elements as system LSI, architecture, or the like. Each embodiment will be embodied as described therein, however, whether or not to perform improvement or modification will be determined depending on a personal opinion of a practitioner.

The reproducing device includes an optical disc player, a tuner, a hard disk player, a memory card player, or the like. The reproducing device configures a source device for the display device. The amplification device includes an AV amplifier which has a function of receiving a stereoscopic image signal from the source device, and transmitting the stereoscopic image signal to a sink device, or the like. The display device includes a liquid crystal display, a plasma display, or the like. The display device configures the sink device for the reproducing device.

Note that both the reproducing device and display device obtain the OSD depth information of the amplification device, the reproducing device may select the OSD display depth of the device itself so that the OSD is to be seen behind the OSD of the amplification device from a viewer, and the display device may select the OSD display depth of the device itself so that the OSD is seen in front of the OSD of the amplification device from a viewer.

The image which is generated in the device itself, and is overwritten (superimposed) on the stereoscopic image (contents or broadcasting image) by the respective reproducing device, display device, and amplification device is not limited to the OSD. Here, such an image superimposed on the stereoscopic image is referred to as a device image (reproducing device image, amplification device image, and display device image). The device image includes all of images which are generated in each device, and are overwritten (superimposed) on the stereoscopic image.

According to the embodiment, the stereoscopic image signal has been described as a stereoscopic image signal of a frame sequential method in which the left eye image and the right eye image are included as separate frames. However, the stereoscopic image signal according to the embodiment is not limited thereto. The embodiment can also be applied to a stereoscopic image signal of a method in which the left eye image and the right eye image are included in the same frame such as a side-by-side method, or a top-and-bottom method.

### INDUSTRIAL APPLICABILITY

Any of the reproducing devices, the display devices, and the amplification devices according to the embodiments can realize an OSD display with high visibility for a viewer, and are useful.

### REFERENCE SIGNS LIST

1: optical disc
2: optical pickup
3: motor
4: demodulation circuit
5: first OSD addition circuit
6: first CPU
7: first HDMI transmission circuit
8: first output terminal
9: first remote controller
10: first cable
20: second cable
100: first reproducing device
200: first display device
201: first input terminal
202: first EDID
203: first HDMI reception circuit
204: second OSD addition circuit
205: second CPU
206: displaying panel
207: glasses control circuit
208: stereoscopic vision glasses
209: second remote controller
210: first audio amplifier
211: first speaker
300: second reproducing device
306: third CPU
307: second HDMI transmission circuit
309: third remote controller
400: second display device
402: second EDID
403: second HDMI reception circuit
404: third OSD addition circuit
405: fourth CPU
500: first amplification device
501: second input terminal
502: third EDID
503: third HDMI reception circuit
504: fourth OSD addition circuit
505: fifth CPU
506: third HDMI transmission circuit
507: second audio amplifier
508: second output terminal
509: fourth remote controller
510: audio output terminal
511: second speaker
600: second amplification device
602: fourth EDID
603: fourth HDMI reception circuit
604: fourth OSD addition circuit
605: sixth CPU
606: fourth HDMI transmission circuit
700: third reproducing device
705: fifth OSD addition circuit
706: seventh CPU
800: third display device
802: fifth EDID
804: sixth OSD addition circuit
805: eighth CPU
1000: first video system
2000: second video system

1. A reproducing device capable of superimposing a reproducing device image different from a stereoscopic image onto the stereoscopic image which can be viewed stereoscopically to generate and output a stereoscopic image signal, comprising:
an acquisition unit operable to obtain information about device image depth, the device image depth being stereoscopic vision depth that a device connected to the reproducing device and capable of superimposing a device image different from the stereoscopic image onto the stereoscopic image gives to the device image when the device superimposes the device image onto the stereoscopic image;
a superimposing unit operable to give reproducing device image depth to the reproducing device image based on the information about device image depth obtained by the acquisition unit and superimpose the reproducing device image onto the stereoscopic image to generate the stereoscopic image signal; and
a transmission unit operable to transmit the stereoscopic image signal to the device.

2. The reproducing device according to claim 1, wherein the superimposing unit gives the reproducing device image depth to the reproducing device image based on the information about device image depth so that the reproducing device image can be viewed with identical depth to the depth of the device image, or can be viewed with deeper depth than the depth of the device image in stereoscopic vision, and superimposes the reproducing device image onto the stereoscopic image.

3. The reproducing device according to claim 1, further comprising a notification unit operable to notify the device of information about reproducing device image depth given by the superimposing unit.

4. A reproducing device capable of superimposing a reproducing device image different from a stereoscopic image onto the stereoscopic image which can be viewed stereoscopically to generate and output a stereoscopic image signal, comprising:
a superimposing unit operable to superimpose the reproducing device image onto the stereoscopic image to generate the stereoscopic image signal; and
a transmission unit operable to transmit the stereoscopic image signal and information about stereoscopic vision depth of the reproducing device image to a device connected to the reproducing device and capable of superimposing a device image different from the stereoscopic image onto the stereoscopic image.

5. A display device capable of superimposing a display device image different from a stereoscopic image onto the stereoscopic image which can be viewed stereoscopically to display the stereoscopic image, comprising:
a reception unit operable to receive a first stereoscopic image signal including the stereoscopic image;
an acquisition unit operable to obtain information about device image depth, the device image depth being stereoscopic vision depth that a device connected to the display device and capable of superimposing a device image different from the stereoscopic image onto the stereoscopic image to output the first stereoscopic image signal gives to the device image when the device superimposes the device image onto the stereoscopic image;
a superimposing unit operable to give display device image depth to the display device image based on the information about device image depth obtained by the acquisition unit and superimpose the display device image onto the stereoscopic image to generate a second stereoscopic image signal; and
a display unit operable to display an image based on the second stereoscopic image signal.

6. The display device according to claim 5, wherein the superimposing unit gives the display device image depth to the display device image based on the information about device image depth so that the display device image can be viewed with identical depth to the depth of the device image, or can be viewed with shallower depth than the depth of the device image in stereoscopic vision, and superimposes the display device image onto the stereoscopic image.

7. The display device according to claim 5, further comprising a notification unit operable to notify the device of information about display device image depth given by the superimposing unit.

8. A display device capable of superimposing a display device image different from a stereoscopic image onto the stereoscopic image which can be viewed stereoscopically to display the stereoscopic image, comprising:
a superimposing unit operable to superimpose the display device image onto the stereoscopic image included in a first stereoscopic image signal to generate a second stereoscopic image signal; and
a transmission unit operable to transmit information about stereoscopic vision depth of the display device image to a device connected to the display device and capable of superimposing a device image being an image different from the stereoscopic image onto the stereoscopic image to output the first stereoscopic image signal.

9. An amplification device capable of receiving a first stereoscopic image signal including a stereoscopic image which can be viewed stereoscopically from a reproducing device and superimposing an amplification device image different from the stereoscopic image onto the stereoscopic image to generate and transmit a second stereoscopic image signal to a display device, comprising:
a reception unit operable to receive the first stereoscopic image signal;
an acquisition unit operable to obtain information about display device image depth, the display device image depth being stereoscopic vision depth that the display device capable of superimposing a display device image different from the stereoscopic image onto the stereoscopic image gives to the display device image when the display device superimposes the display device image onto the stereoscopic image;
a superimposing unit operable to give amplification device image depth to the amplification device image based on the information about display device image depth obtained by the acquisition unit and superimpose the amplification device image onto the stereoscopic image to generate a second stereoscopic image signal; and
a transmission unit operable to transmit the second stereoscopic image signal to the display device.

10. The amplification device according to claim 9, wherein the superimposing unit gives the amplification device image depth to the amplification device image based on the information about display device image depth so that the amplification device image can be viewed with identical depth to the depth of the display device image, or can be viewed with deeper depth than the depth of the display device image in stereoscopic vision, and superimposes the amplification device image onto the stereoscopic image.

11. The amplification device according to claim 9, further comprising a notification unit operable to notify at least one of the reproducing device and the display device of information about amplification device image depth given by the superimposing unit.

12. An amplification device capable of receiving a first stereoscopic image signal including a stereoscopic image which can be viewed stereoscopically from a reproducing device and superimposing an amplification device image different from the stereoscopic image onto the stereoscopic image to generate and transmit a second stereoscopic image signal to a display device, comprising:
a reception unit operable to receive the first stereoscopic image signal;
a superimposing unit operable to superimpose the amplification device image onto the stereoscopic image to generate the second stereoscopic image signal;
a transmission unit operable to transmit the second stereoscopic image signal to the display device; and
a notification unit operable to notify at least one of the reproducing device and the display device of information about stereoscopic vision depth of the amplification device image.

13. An amplification device capable of receiving a first stereoscopic image signal including a stereoscopic image which can be viewed stereoscopically from a reproducing device and superimposing an amplification device image different from the stereoscopic image onto the stereoscopic image to generate and transmit a second stereoscopic image signal to a display device, comprising:
a reception unit operable to receive the first stereoscopic image signal;
an acquisition unit operable to obtain information about reproducing device image depth, the reproducing device image depth being stereoscopic vision depth that the reproducing device capable of superimposing a reproducing device image being an image different from the stereoscopic image onto the stereoscopic image gives to the reproducing device image when the reproducing device superimposes the reproducing device image onto the stereoscopic image;
a superimposing unit operable to give amplification device image depth to the amplification device image based on the information about reproducing device image depth obtained by the acquisition unit and superimpose the amplification device image onto the stereoscopic image to generate the second stereoscopic image signal; and
a transmission unit operable to transmit the second stereoscopic image signal to the display device.

14. The amplification device according to claim 13, wherein the superimposing unit gives the amplification device image depth to the amplification device image based on the information about reproducing device image depth so that the amplification device image can be viewed with identical depth to the depth of the reproducing device image, or can be viewed with shallower depth than the depth of the reproducing device image in stereoscopic vision, and superimposes the amplification device image onto the stereoscopic image.

15. The amplification device according to claim 13, further comprising: a notification unit operable to notify at least one of the reproducing device and the display device of information about amplification device image depth given by the superimposing unit.

16. A video system including a reproducing device, a display device, and an amplification device,
wherein the reproducing device is capable of superimposing a reproducing device image different from a stereoscopic image onto the stereoscopic image which can be viewed stereoscopically to generate and output a first stereoscopic image signal, the reproducing device comprising:
an acquisition unit operable to obtain information about amplification device image depth, the amplification device image depth being stereoscopic vision depth that the amplification device connected to the reproducing device and capable of superimposing a amplification device image different from the stereoscopic image onto the stereoscopic image gives to the amplification device image when the amplification device superimposes the amplification device image onto the stereoscopic image;
a superimposing unit operable to give reproducing device image depth to the reproducing device image based on the information about amplification device image depth obtained by the acquisition unit and superimpose the reproducing device image onto the stereoscopic image to generate the first stereoscopic image signal; and
a transmission unit operable to transmit the first stereoscopic image signal to the amplification device,
wherein the amplification device is capable of receiving the first stereoscopic image signal from the reproducing device and superimposing the amplification device image different from the stereoscopic image onto the stereoscopic image to generate and transmit a second stereoscopic image signal to a display device, the amplification device comprising:
a reception unit operable to receive the first stereoscopic image signal;
an acquisition unit operable to obtain information about display device image depth, the display device image depth being stereoscopic vision depth that the display device capable of superimposing a display device image different from the stereoscopic image onto the stereoscopic image gives to the display device image when the display device superimposes the display device image onto the stereoscopic image;
a superimposing unit operable to give the amplification device image depth to the amplification device image based on the information about display device image depth obtained by the acquisition unit and superimpose the amplification device image onto the stereoscopic image to generate the second stereoscopic image signal; and
a transmission unit operable to transmit the second stereoscopic image signal to the display device, and
wherein the display device is capable of receiving the second stereoscopic image signal from the amplification device and superimposing the display device image being an image different from the stereoscopic image onto the stereoscopic image to display the stereoscopic image, the display device comprising:
a reception unit operable to receive the second stereoscopic image signal;
a superimposing unit operable to give the display device image depth to the display device image and superimpose the display device image onto the stereoscopic image to generate a third stereoscopic image signal; and
a display unit operable to display an image based on the third stereoscopic image signal.

17. The video system according to claim 16, wherein:
the superimposing unit of the reproducing device gives the reproducing device image depth to the reproducing device image based on the information about amplification device image depth so that the reproducing device image can be viewed with identical depth to the depth of the amplification device image, or can be viewed with deeper depth than the depth of the amplification device image in stereoscopic vision, and superimposes the reproducing device image onto the stereoscopic image; and
the superimposing unit of the amplification device gives the amplification device image depth to the amplification device image based on the information about display device image depth so that the amplification device image can be viewed with identical depth to the depth of the display device image, or can be viewed with deeper depth than the depth of the display device image in stereoscopic vision, and superimposes the amplification device image onto the stereoscopic image.

18. The video system according to claim 16, wherein the amplification device further comprising a notification unit operable to notify the reproducing device of information about amplification device image depth.

19. The video system according to claim 16, wherein the display device further comprising a notification unit operable to notify the amplification device of information about display device image depth.

20. A video system including a reproducing device, a display device, and an amplification device,
wherein the reproducing device is capable of superimposing a reproducing device image different from a stereoscopic image onto the stereoscopic image which can be viewed stereoscopically to generate and output a first stereoscopic image signal, the reproducing device comprising:
a superimposing unit operable to give reproducing device image depth of a predetermined stereoscopic vision depth to the reproducing device image and superimpose the reproducing device image onto the stereoscopic image to generate the first stereoscopic image signal; and
a transmission unit operable to transmit the first stereoscopic image signal to the amplification device,
wherein the amplification device is capable of receiving the first stereoscopic image signal from the reproducing device and superimposing an amplification device image different from the stereoscopic image onto the stereoscopic image to generate and transmit a second stereoscopic image signal to a display device, the amplification device comprising:
a reception unit operable to receive the first stereoscopic image signal;
an acquisition unit operable to obtain information about reproducing device image depth;
a superimposing unit operable to give amplification device image depth to the amplification device image based on the information about reproducing device image depth obtained by the acquisition unit and superimpose the amplification device image onto the stereoscopic image to generate the second stereoscopic image signal; and
a transmission unit operable to transmit the second stereoscopic image signal to the display device, and
wherein the display device is capable of receiving the second stereoscopic image signal from the amplification device and superimposing a display device image different from the stereoscopic image onto the stereoscopic image to display the stereoscopic image, the display device comprising:
a reception unit operable to receive the second stereoscopic image signal;
an acquisition unit operable to obtain information about amplification device image depth;
a superimposing unit operable to give display device image depth to the display device image based on the information about amplification device image depth obtained by the acquisition unit and superimpose the display device image onto the stereoscopic image to generate a third stereoscopic image signal; and
a display unit operable to display an image based on the third stereoscopic image signal.

21. The video system according to claim 20, wherein:
the superimposing unit of the amplification device gives the amplification device image depth to the amplification device image based on the information about reproducing device image depth so that the amplification device image can be viewed with identical depth to the depth of the reproducing device image, or can be viewed with shallower depth than the depth of the reproducing device image in stereoscopic vision, and superimposes the amplification device image onto the stereoscopic image; and
the superimposing unit of the display device gives the display device image depth to the display device image based on the information about amplification device image depth so that the display device image can be viewed with identical depth to the depth of the amplification device image, or can be viewed with shallower depth than the depth of the amplification device image in stereoscopic vision, and superimposes the display device image onto the stereoscopic image.

22. The video system according to claim 20, wherein the transmission unit of the reproducing device transmits the information about reproducing device image depth in addition to the first stereoscopic image signal to the amplification device.

23. The video system according to claim 20, wherein the transmission unit of the amplification device transmits the information about amplification device image depth in addition to the second stereoscopic image signal to the display device.
